(19) United States
(12) Patent Application Publication
(10) Pub. No.: US 2004/0243484 A1
(43) Pub. Date: Dec. 2, 2004

(54) System and method for facilitating customs compliance in the importation of merchandise

(76) Inventor: Todd R. Smith, Corona del Mar, CA (US)

Correspondence Address: BROWN, RAYSMAN, MILLSTEIN, FELDER & STEINER LLP, 900 THIRD AVENUE, NEW YORK, NY, 10022, US

(21) Appl. No.: 10/773,096

(22) Filed: Feb. 5, 2004

Related U.S. Application Data
(60) Provisional application No. 60/445,013, filed on Feb. 5, 2003.

(51) Int. Cl. G06F 17/60

(52) U.S. Cl. 705/27

(57) ABSTRACT

Methods and methods are provided for facilitating compliance with customs compliance in the importation of merchandise. Information related to an item of merchandise for import is entered and stored to a networked method. Parties to the import transaction are entered and stored to the method in association with the merchandise information. A network database is searched to obtain information related to the item of merchandise to obtain a classification of the merchandise. Parties involved in the transaction are notified of the classification results and may act upon the classification result. The information related to the import transaction, merchandise, classification and action of the parties is stored in a report for recordkeeping and to create an audit trail.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF INVENTION

The invention disclosed herein relates generally to facilitating compliance with customs requirements (e.g., laws, regulations, procedures, etc.) in the importation of merchandise (also referred to as good(s)). “Merchandise” is used herein in a broad sense and encompasses materials and finished and partly finished products unless the context indicates otherwise. Among other things, compliance with customs requirements typically involves classifying entering merchandise and, at least with respect to the United States Bureau of Customs and Border Protection (“CBP”), documenting the classification process, which is sometimes referred to as recordkeeping, and/or creating an audit trail.

All merchandise entering the United States must be declared to CBP and is subject to detention and examination by CBP. The CBP requires that the importer provide the value of the entering merchandise and its tariff classification in the Customs declaration which must be made according to the harmonized tariff schedule (“HTS”). In addition, CBP recently implemented new rules effective Dec. 2, 2002, requiring that a manifest for goods bound for the United States be submitted several hours before the cargo is laden aboard a vessel, e.g., plane, truck or plane, at a foreign port. The cargo declaration must include the product classification information provided as an HTS code, if possible, or a precise description of the product.

Classification of merchandise requires familiarization with the HTS and its international counterpart, the Harmonized Commodity Description and Coding System, and assists CBP in assessing tariffs, and determining whether merchandise is subject to quotas, restraints, licensures with other government agencies, embargoes or other restrictions. Properly classifying merchandise and keeping up with changes to the HTS classifications, customs regulations, and revocations and modifications to customs rulings is time consuming and difficult. Customs rulings, which are a binding classification determination by CBP on specific merchandise, may be obtained by individuals pursuant to 19 C.F.R. § 177. Nevertheless, an importer must use “reasonable care” in classifying the merchandise, assessing the value of the merchandise and rate of duty, and in filing documentation with CBP. In addition, all importers, owners, consignees or persons filing documentation with CBP must archive records for examination by CBP for five years. If a record keeper fails to produce records to CBP, fines of as much as US$100,000 can be levied.

The practice for reasonable care varies depending on the experience of the importer, and as such, there are many ways to exercise reasonable care. CBP recommends that importers use experts for assistance in complying with customs requirements, a practice most importers follow. If an importer does not use an expert, CBP suggests that the importer refer to the customs regulations and have an individual familiar with the regulations and the merchandise review the classification process and supporting documentation to ensure accuracy in the tariff classification of the entering merchandise, its assessed value, etc. As mentioned above, importers may also obtain a ruling by CBP regarding the description of merchandise or its tariff classification, or a pre-classification from CBP relating to proper description and classification of the merchandise. CBP also recommends that importers develop a reliable program to maintain and produce required customs documentation and the supporting information surrounding the classification of merchandise.

Customs organizations of other countries likewise have requirements governing classification of merchandise entering the respective country and documentation thereof.

### SUMMARY OF INVENTION

The invention provides a method and system (“System”) and computer product for facilitating compliance with customs requirements relating to the importation of merchandise. Among other things, the invention may be used in classifying entering merchandise, documenting the classification process and storing or archiving information to support the classification.

In accordance with the invention, information that may support a particular classification determination is selected for storage, in electronic, magnetic, optical, or other suitable non-hard copy form in a suitable storage device in association with a particular classification determination, e.g., in association with a reference to, or identification of, the particular classification determination, such as a unique ID number. Storage of such information may be offered in support of any customs requirement to document or to preserve documentation of a classification determination.

The information to be stored may be provided in the format in which it is stored, or may be provided in one format, used in that format during the classification process, and then converted to the format in which it is stored. For example, information to be stored may be selected from a text searchable information or document database and converted to a field searchable or non-searchable format prior to storing the information in the storage device in association with the particular classification determination. The information selected for storage is preferably converted to a page or document format, such as portable document format (PDF), XML or HTML (or other mark-up language document). The invention provides for access to the stored information in association with the classification determination.

In a preferred embodiment, the invention provides for the initial storage of selected information in association with a particular classification determination, e.g., during a classification process, and for the storage of selected information thereafter, e.g., for archival purposes. In one embodiment, information identified using a search, for example, or otherwise, may be selected for initial storage in association with a particular classification determination underway (e.g., for which an ID or reference has been assigned). In another embodiment, such information may be identified without first assigning an ID or reference to a particular classification determination, which preferably can be assigned thereafter. Preferably, the invention provides a user interface accessible from a document storage or retrieving interface, with which the identified information has or will be stored or viewed, for assigning an ID or reference to a particular classification process in association with which the identified information is then stored.

In one embodiment, the selection of information to be stored initially provides for storage of a link or links to the selected information, which can either be stored in association with a particular classification determination to which an ID or reference has been assigned, or can be stored, e.g., for later association with a particular classification determination. In general, a link is a connection between at least two points, such as a reference, word, picture (such as a target or bull eye), object or other point, that is preferably selectable, including, for example, a hyperlink. The storage of such links does not require storage of the information itself. Activation of a stored link, such as by selection of the link, will cause the information associated with the link to be electronically displayed.

In a preferred embodiment, selected information itself, which may have been used during the classification process or which supports a particular classification, is placed in storage upon or after a completion of the classification process.

A classification determination made using the invention may involve review, input, comment, concurrence, approval, etc., by more than one person. A person or user authorized to originate a classification determination, e.g., by assigning an ID or reference to the classification determination, is referred to herein as an originator. Other parties, persons, or users, e.g., experts, advisors, co-employees, sometimes referred to herein as a “participant,” or “responsible party,” may be given authority to access information stored in association with a particular classification determination for purposes such as review, comment, approval, etc. Such participants or responsible parties are also preferably given access to information accessible by an originator with the ability to initially store or suggest initial storage in association with a particular classification determination. An authorized person or user may be an originator, a participant or a responsible party. Completion of a classification process may involve approval by one or more participants authorized to participate in the particular classification determination (in addition to an originator of the particular classification determination). Storage of the information may be local to the originator and/or a participant, or preferably accessible over a network.

In another embodiment of the invention, an originator, participant or responsible party may add or upload merchandise information to a database, such as a product catalog. The originator, participant or responsible party may select each merchandise item to undergo the classification determination process. In general, the classification determination process is a process further described herein in which a merchandise item is associated with country HS codes. Preferably, at any time during the classification determination process, the status of the classification determination process for each item of merchandise entered in the product catalog can be obtained by authorized users. Classification determination status can be, e.g., ‘classified,’ ‘not started,’ or ‘update required,’ etc.

In the description below of the preferred embodiments, a function referred to herein as “DOIT” or alternatively “grab” function provides initial storage of a reference to selected information. As used herein, “DOIT” and “grab” refer to functions which provide the same type of functionality. A function referred to herein as “DOCIT” or alternatively “cDocs” function provides for storage of selected information in association with a classification determination. As used herein, “DOCIT” and “cDocs” refer to functions which provide the same functionality. The DOIT or grab function may be used in connection with the DOCIT function, or separately to provide initial storage to information selected generally, e.g., outside of the scope of a classification determination. The DOIT or grab function can select references to results or references to information, which can be stored and used as a basis for other System functions, e.g., setting an alert, obtaining merchandise classification information, including global tariffs or other information. The DOCIT or cDocs function may also be used independently of the DOIT or grab function. The DOIT or grab and DOCIT or cDocs and other functionality described herein may be activated by selecting a “grab” icon, such as a target, bull's eye, or other graphic icon representing the function. A grab icon preferably appears in screens throughout the system and method to indicate where a function may be selected for use individually or in combination with other functions.

In a preferred embodiment of the invention, access is provided to the originator, participant(s), and responsible parties to information that may be useful in a classification determination, such as tariff schedules, regulations, etc., and such information may be selected for storage in association with a classification determination, as discussed above. Classifying merchandise entering a country may involve research into information such as relevant tariff schedules, court cases, laws and regulations, administrative decisions and rulings (e.g., CBP rulings and United States Treasury decisions for importation into the United States, HTS memorandums, notices, etc.) In the preferred embodiment, this information is stored in a searchable format, and the selection process may involve one or more searches to identify information that relates to a particular classification determination, e.g., information that may possibly support or provide some or all of the basis for, or otherwise be relevant to, the particular classification determination.

In a preferred embodiment, information selected during a classification process, may be initially stored in network accessible storage or stored locally, as discussed above, for use by authorized persons or responsible parties, and after completion of a determination, selected information may be stored in network accessible storage for access by authorized persons. Similarly, in a preferred embodiment, information that may be useful in a classification determination is stored in network accessible storage, in association with the classification determination, for access by authorized persons. In a preferred embodiment, such stored information is accessible over a network such as a LAN, WAN, intranet or the Internet. In such an embodiment, only authorized persons have access to network storage and associated application software for implementing the invention.

In a preferred embodiment, information stored for use during a classification process may be used by persons other than the originator, such as participants, responsible parties or other persons authorized by the user, as described above. In one embodiment, participants may be selected who can provide feedback on a classification determination in progress and who must provide an indication of concurrence, agreement or approval before a classification determination is completed. The indication by such participant or other authorized persons may be used as a triggering event for storing information, e.g., for archival purposes, as discussed above, upon completion of a classification determination.

The one or more persons, or participant(s) approving the classification process may be authorized, e.g., by an originator, in any suitable way. In one embodiment, a preferred list of advisors, experts, or responsible parties, each of whom may be provided with authorization in connection with a specific classification determination, may be stored in network storage in association with a particular originator. In a preferred embodiment, these advisors must become authorized System users and subscribe to or otherwise obtain authorization to use the System in order to access information associated with a particular classification determination. In another embodiment, the originator may invite advisors by email or other means of communication to register or subscribe to use the System.

Alternatively, a directory of advisors (and/or experts) may be provided in network accessible storage that an originator or authorized user can search to find an appropriate advisor or participant. An advisor found in such a search, or an advisor identified in any suitable manner, may then either be authorized as an authorized person or user. In a preferred embodiment, access to and/or advisor inclusion in this directory of advisors (experts) may require a fee.

The invention provides in a preferred embodiment a searchable source or sources e.g., one or more databases, or third party databases, of information of the type disclosed herein that may be useful in a classification determination, and other relevant information, accessible over a network. The customs-related information may be, e.g., manually entered, or uploaded from an existing database, or obtained by searching a database, e.g., of customs-related information that may be used in the classification process. In accordance with one embodiment of the invention, information accessed from this source or sources may be used to document a classification and may be stored in association with a classification determination, both initially and upon completion of the classification process as discussed herein.

In a preferred embodiment, the searchable database(s) of customs-related information include, for example: product classifications, customs laws, regulations, rulings, directives, registrations, duty notices, foreign codes, tariff schedules, World Customs Organization explanatory notes, encyclopedias, and a directory of customs advisors (experts).

In a preferred embodiment of the invention, a classification determination is initiated by entering information relating to the importation of merchandise into a computer using functionality provided by the invention, which assigns a unique ID or reference, referred to herein as a DOCIT or cDocs. A classification determination proceeds with participation as disclosed herein. Once a classification determination has been made, a report (“Report”) is generated and the Report and any selected information (e.g., documents or files) related to the determination are stored for archival purposes, for example, for recordkeeping or creating an audit trail. All or some of this information may be initially stored as described above. Although network accessible storage is preferred, the report and selected information may be stored locally or in a portable storage medium such as CD-ROM or DVD, or the stored information may be electronically transmitted to authorized person, e.g., by email. In the network storage embodiment, authorized persons are permitted to access the stored Report and selected information over a network.

The information that is stored in association with a classification determination (DOCIT or cDocs function) reference or initially stored (DOIT or grab function) may be monitored for changes. For example, regulations, rulings, laws, US Treasury and other administrative decisions, court cases, tariff schedules, queries as to importation restrictions, landed cost estimates, and multi-country tariffs, etc., may be monitored for changes or a related subsequent ruling that affects an earlier ruling, etc., and an alert may be generated when such a change has been detected. The alert may be provided to persons either associated with a DOCIT or cDocs or identified in an alert list.

In a preferred embodiment, a DOCIT or cDocs contains information relating to classification of the merchandise, applicable regulations, product information, manufacturer, country of origin, supplier, etc. and authorized or responsible parties, and an approval or review action to be taken by each responsible party. Responsible parties may be associated with a DOCIT or cDocs from a list of advisors, maintained for a DOCIT or cDocs originator, or obtained by searching a database, as described above. The DOCIT or cDocs reference is sent, e.g., via electronic mail, to each responsible party for his/her approval and/or review, and upon approval by all of the required responsible parties, all information associated with the DOCIT or cDocs is automatically stored for archival purposes, as described above, for example, record keeping or creating an audit trail. In a preferred embodiment, the information is converted to, or compiled in, a read-only document format if not already in such a format. Information previously stored as a link is retrieved using the link, converted and stored in association with the DOCIT or cDocs. The stored DOCIT or cDocs is archived in network storage and/or is sent, e.g., via electronic mail, to the originator, and authorized persons for local storage.

In a preferred embodiment, a classification determination or DOCIT/cDocs Report includes, for example, the classification of the merchandise, the identity of advisors and their actions related to classifying the merchandise, import duties for the merchandise, etc., and copies of regulations (and other information) relied upon in classifying the merchandise. To comply with customs regulations, the archived materials should be stored for at least five years. The Report can be used to provide a compliance audit trail for the classification of merchandise that are to be imported into a country, and with respect to CBP, the Report may be offered as evidence of compliance with CBP's “reasonable care” standard for classification of merchandise and record keeping.

In a preferred embodiment, the invention provides for the functionality described herein implemented using the Internet (or any suitable computer or communications system). The invention provides server side software and a web site accessible by electronic devices equipped with suitable browser software and an Internet connection. In this embodiment, both the initial and later storage described above are network storage that may be accessible by computer or other device or means having a browser and a connection to the Internet.

The invention further provides computer readable medium or media having computer programming and or coding for causing a computer or computer system to perform the functionality described herein.

The invention also provides a business method or methods by which a provider of the computer readable medium or media, or a provider of services (“Service(s)”) and/or a System that involves use of the medium or media and/or storage of or access to the information described herein, charges or receives compensation for such Services and or use. In some embodiments, subscriptions are provided to users in different classes or levels. The classes or levels can be user types, e.g., based on a user's role in the classification process, affiliation with an organization, government, company or other entity. In one embodiment, free access to the system is provided to some user types as inducement to attract other user types to pay to use the system.

### BRIEF DESCRIPTION OF DRAWINGS

The foregoing and other aspects of the invention will become more readily apparent from the following description of illustrative embodiments thereof and the accompanying drawings, which illustrate the invention in an exemplary and non-limiting fashion, and in which like or similar references in the different figures indicate the same, similar or corresponding items:

FIG. 1 is block diagram of a computer system configured according to the invention to perform methods provided by the invention;

FIGS. 2 and 2A depict screens provided by the computer system depicted in FIG. 1 from which a function may be selected in the method(s) represented by the flow charts in FIGS. 10-12, according to an embodiment of the invention;

FIGS. 3 and 3A depict screens provided by the computer system depicted in FIG. 1 in response to selection of the DOCIT or cDocs menu item from the screens depicted in FIGS. 2 and 2A, respectively, which display summaries by existing Reports generated by the DOIT or grab and DOCIT/cDocs functions;

FIGS. 4 and 4A depict screens provided by the computer system depicted in FIG. 1 from which a DOCIT/cDocs is created or edited according to the DOCIT/cDocs function in the method represented by the flow charts in FIGS. 10-12, illustrating a created DOCIT/cDocs;

FIGS. 5 and 5A depict screens provided by the computer system depicted in FIG. 1 from which an alert is created or edited in a method according to an embodiment of the invention;

FIGS. 6 and 6A depict screens provided by the computer system depicted in FIG. 1 from which one or more databases of customs-related information may be searched in a method according to an embodiment of the invention;

FIGS. 7A-7B and 7C-7E, depict screens provided by the computer system depicted in FIG. 1 from which a DOIT/grab function may be selected in a method represented by the flow charts in FIGS. 8 and 10, and the resulting pop-up screen when a DOIT/grab function is selected;

FIG. 8 depicts a screen provided by the computer system depicted in FIG. 1 in response to selection of the menu item “Rulings & Other” from the screens depicted in FIGS. 4 and 4A;

FIGS. 9A-9B and 9C-9F, depict screens showing Reports generated by the computer system depicted in FIG. 1;

FIG. 10 is a flowchart of a method according to a preferred embodiment of the invention for performing a method or methods according to the invention;

FIG. 11 is a flowchart of the process for creating a DOCIT/cDocs in the method represented by FIG. 10, according to an embodiment of the invention;

FIG. 12 is a flowchart of the process of performing a DOIT/grab function in the method represented by FIG. 10, according to an embodiment of the invention; and

FIG. 13, consisting of FIGS. 13A-13F, is a database schema of a database according to an embodiment of the invention used by methods and System incorporating the invention.

### DETAILED DESCRIPTION OF PREFERRED EMBODIMENTS

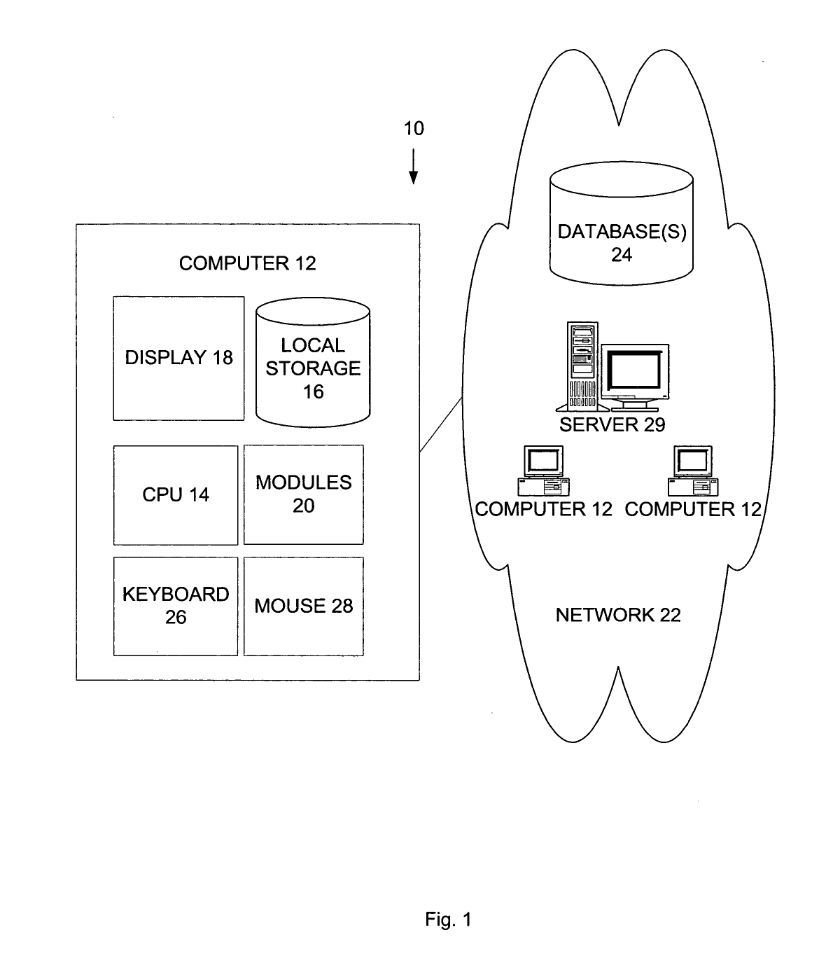

Referring to FIG. 1, a computer 12 for carrying out the inventive method(s), either as a stand-alone or in a System 10 together with a network 22, comprises a CPU 14, local storage 16, display 18, one or more software and/or hardware modules 20 (e.g., applications software such as an Internet browser, hardware and software for connecting to a network such as the Internet, hardware and software for accessing local storage 16 and portable storage, etc.), a mouse or other pointing device 28 and a keyboard or other input device 26. The local storage 16 may comprise one or more hard drives, floppy disc drives, CD-ROM or DVD drives, portable storage devices, etc. Although it is preferred that the computer 12 operate in a network 22 with network accessible storage or database(s) 24, computer 12 can perform non-networked embodiments of the inventive methods. In the non-networked embodiments, the storage functions described herein are provided by local storage 16 and/or the modules 20. In such non-networked embodiments, information needed to be provided to other computers of originators, authorized users, advisors, etc., can be provided on portable storage devices (e.g., CD-ROM, DVD, ZIP drive devices, etc.), or files can be transmitted between computers by a transmission link such as the Internet.

In the preferred embodiment, computer 12 is connected in System 10 with the network 22 in which other computers 12 of other network users are also connected. The following description is made with respect to the System 10/network 22 embodiment depicted in FIG. 1 with the understanding that description of applicable functionality applies to a non-networked embodiment. Also, in the preferred embodiment, the computers 12 and the database(s) 24 are networked over the Internet, and the network includes one or more web servers 29, as is conventional for Internet applications. In the preferred embodiment, as mentioned, modules 20 include a web browser and communications software and hardware for communicating over the Internet.

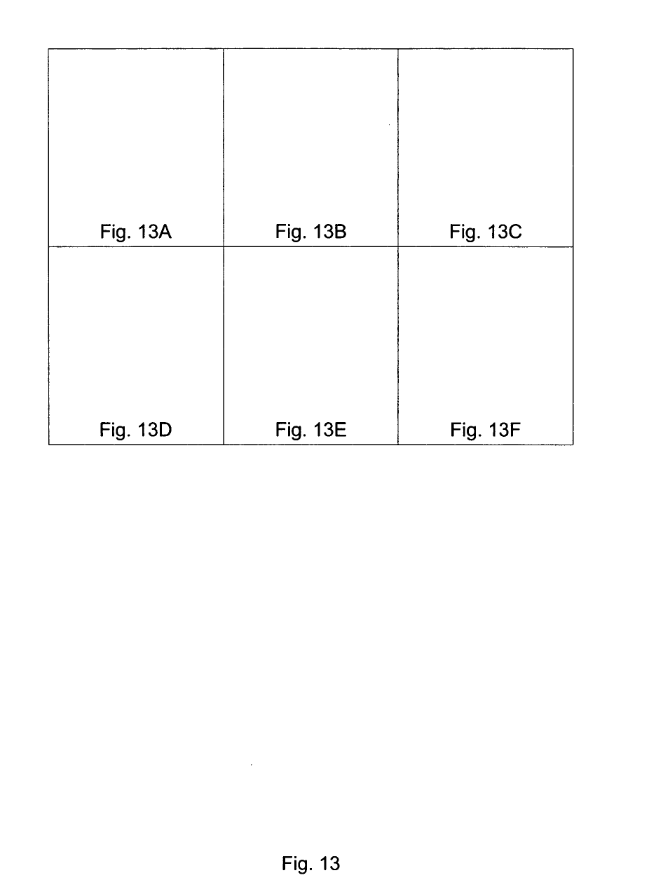

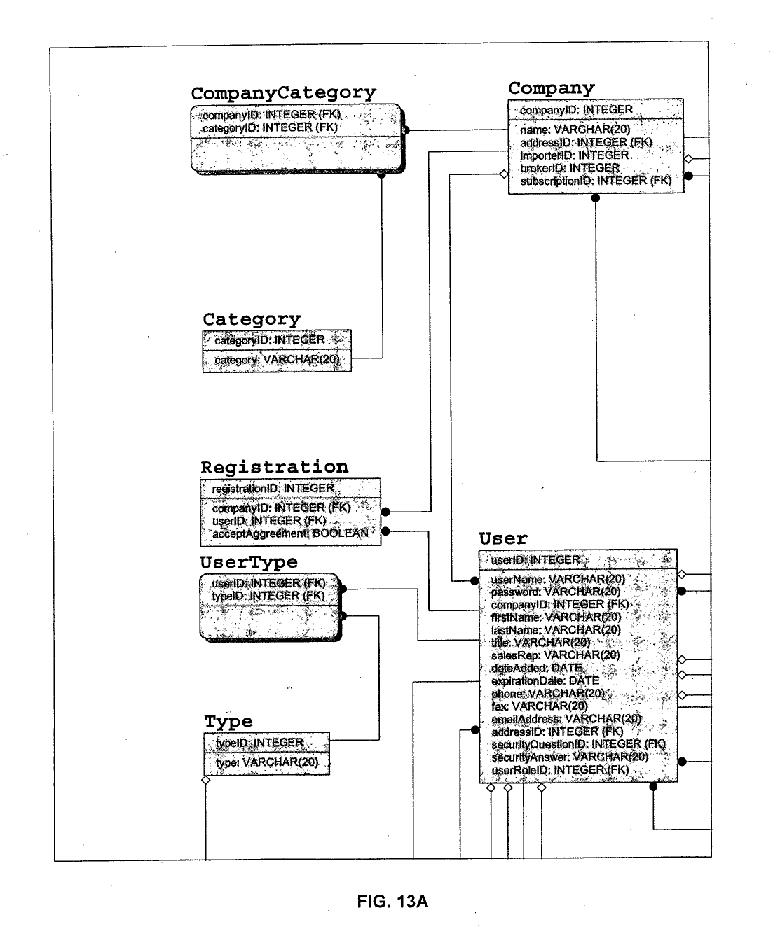

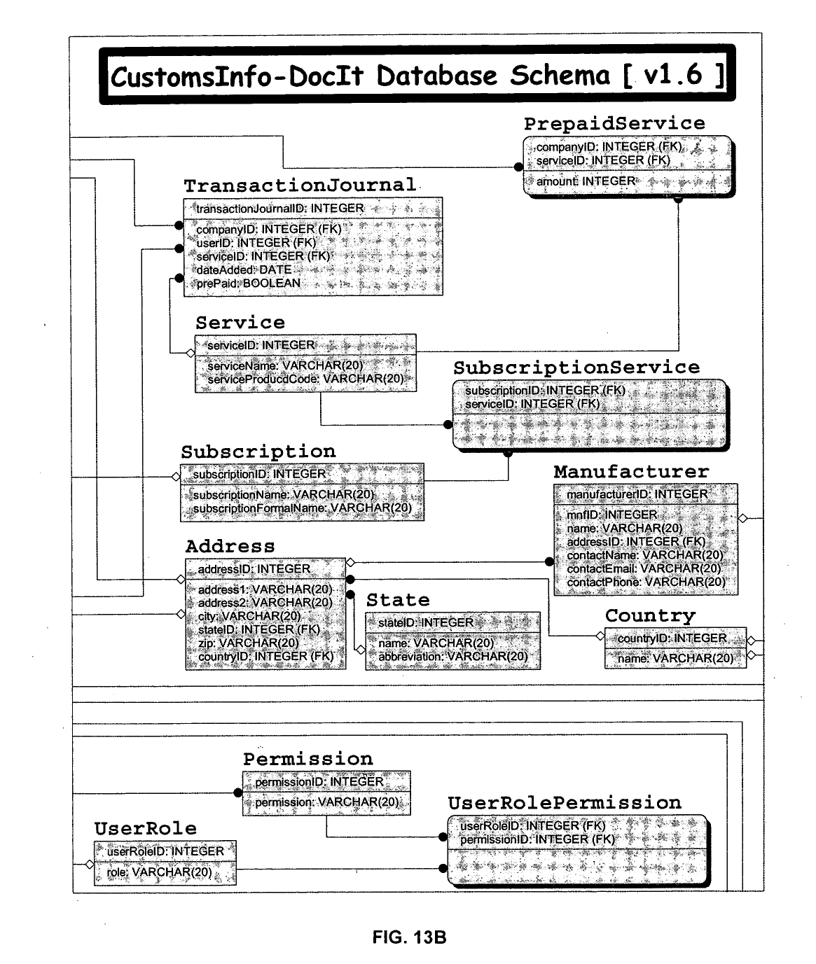

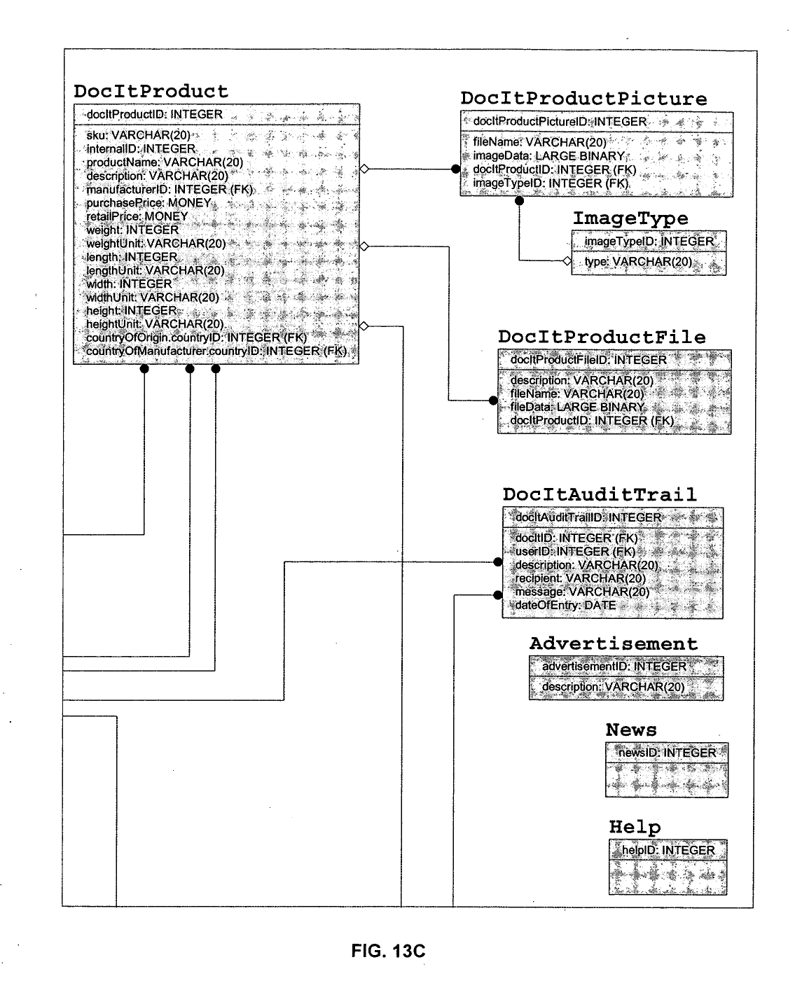

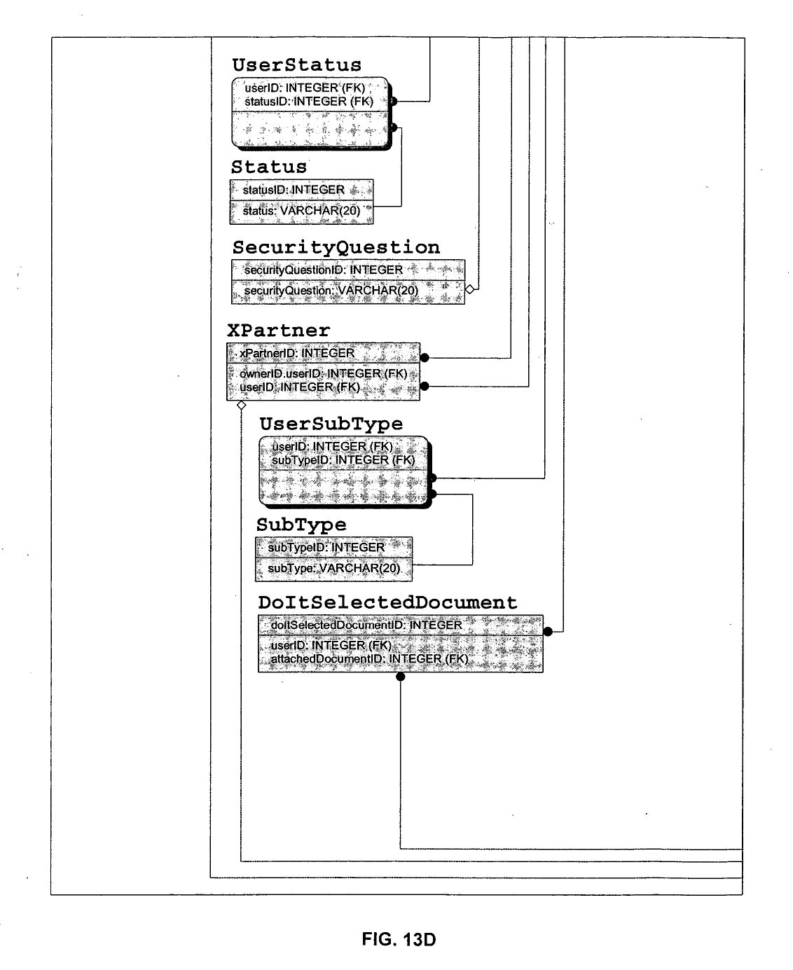

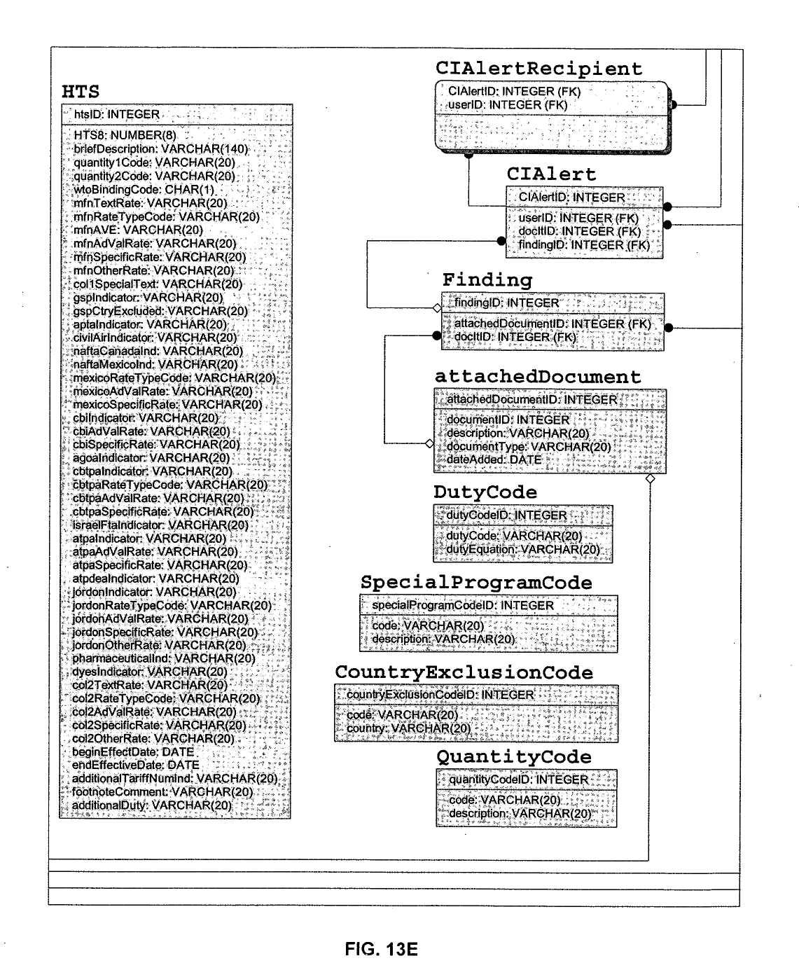

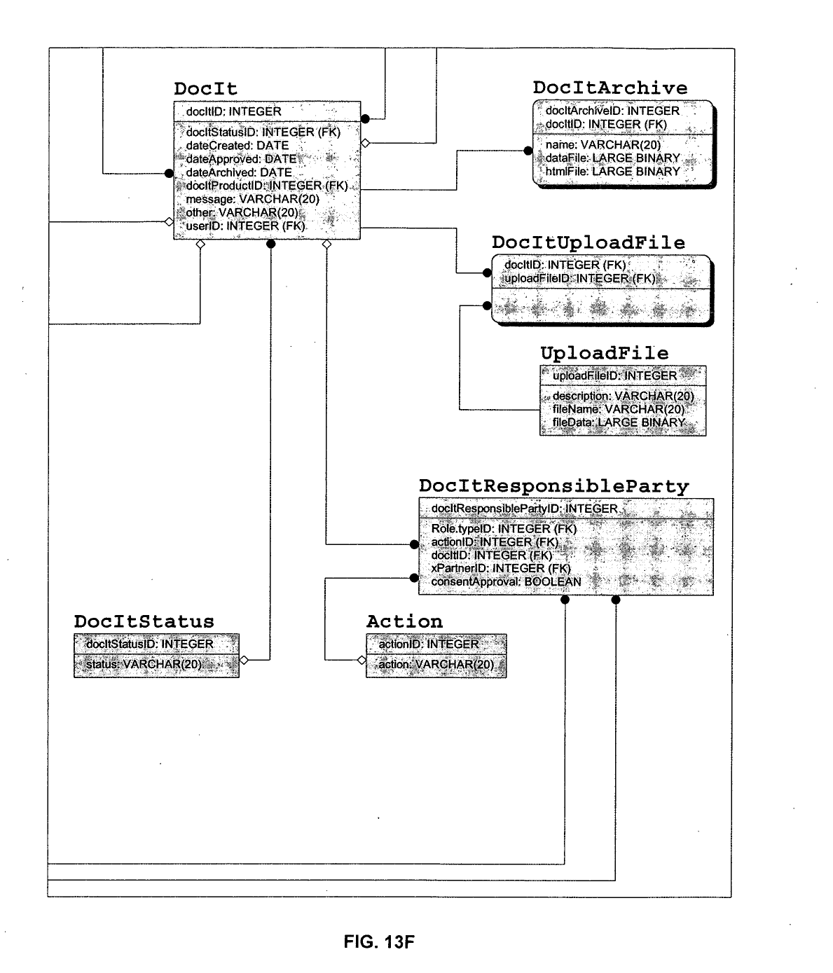

The database(s) 24 store the information described herein for initial storage during a classification process and the information described herein for storage (e.g., archiving) after completion of a classification determination. (In a non-networked embodiment, those storage functions are provided by local storage 16 and/or modules 20.) The database(s) 24 also store information related to originators, authorized persons, etc., subscriptions, billing, and other information. FIG. 13 depicts the schema for a relational database in which the information referred to immediately above and other information is stored.

The database(s) 24 also store the customs-related information described herein related to requirements for importation of merchandise and customs regulations for the United States and other nations. This information includes, for example: Title 19 of the United States Code, Title 19 of the Code of Federal Regulations, the Federal Register, the current and historic United States Harmonized Tariff Schedule, the Customs Bulletin and Decisions published by the General Printing Office, the information obtained from the U.S. Customs Service website and Customs Electronic Bulletin Board, Customs Rulings of Headquarters, New York, District Decisions, and Port Decisions including revoked and modified rulings, World Customs Organization Explanatory Notes, Department of Treasury Decisions, Administrative Messages, Customs Directives, court cases from the Court of International Trade and Court of Appeals for the Federal Circuit, Supplements and Change Orders, Harmonized Commodity Description and Coding System Explanatory Notes, and Canadian customs information, such as: the current and historic Canadian Tariff Schedule, Canadian Explanatory Notes, D-Series Memorandum, Canadian Customs Notices and Proposals, NAFTA, Canadian Acts and Regulations, Canadian Special Import Measures Act and Regulations, Canadian Case Law, as well as directory information related to customs expert advisors.

In preferred embodiments, at least an originator may register or subscribe to use the Service (method(s)) provided by a stand alone computer 12 or the System 10 depicted in FIG. 1 and described herein, and access the network database(s) 24, select System functions such as DOCIT/cDocs, DOIT or grab, create an alert and search network database(s) 24 for customs-related information (or otherwise be provided with such databases and search capability locally). A user may subscribe in any suitable manner. In general, users may be individuals, or entities such as governmental agencies, companies, private enterprises, or other entities. The System operator or Service provider may charge for subscription and other usage of the Service and System. The system subscription or use charges may vary depending on user types, classes of users, levels of users, or other categories of users. For example, users associated with the government, non-profit organizations, advisors or other users may receive free access to the system as an inducement to attract paying subscribers. DOCIT/cDocs originators may be charged for system access at a different level than other participants or authorized users having access to a DOCIT/cDocs. For example, a user may be charged on a subscription basis which allows the user full use of the Service including originating a DOCIT/cDocs, or a user may be charged on a per use basis or pre-pay for specific uses, e.g., for each DOCIT/cDocs or for using the database containing customs-related information, or advisors and others may be charged a registration fee and have limited use of the Service and System, e.g., be able to participate in a DOCIT/cDocs, but not originate one. A base subscription, for example, may comprise unlimited searches in some or all of the database(s) 24, and a limited number of DOCIT/cDocs. A premium subscription, for example, may comprise unlimited searches of all of the databases (24), and a greater number of DOCIT/cDocs. Other users may be provided free use of the Service, such as governmental agencies, non-profit organizations, or other users and may be provided access to limited functionality and information so as to be able to participate in a classification determination. Such use may be covered by a subscription of another user, or another user may be charged a fee for use by additional persons. Another revenue stream may be targeted advertising related to advisors or news provided by or to the System. Such advertising and news may be targeted based on user profiles obtained during a registration process, or by monitoring classification processes as to product type, for example. Preferably, such advertising or news is provided over the network 22 either from database(s) 24 or from other databases or providers. Such revenue stream and others and the above business model, constitute inventive methods described herein.

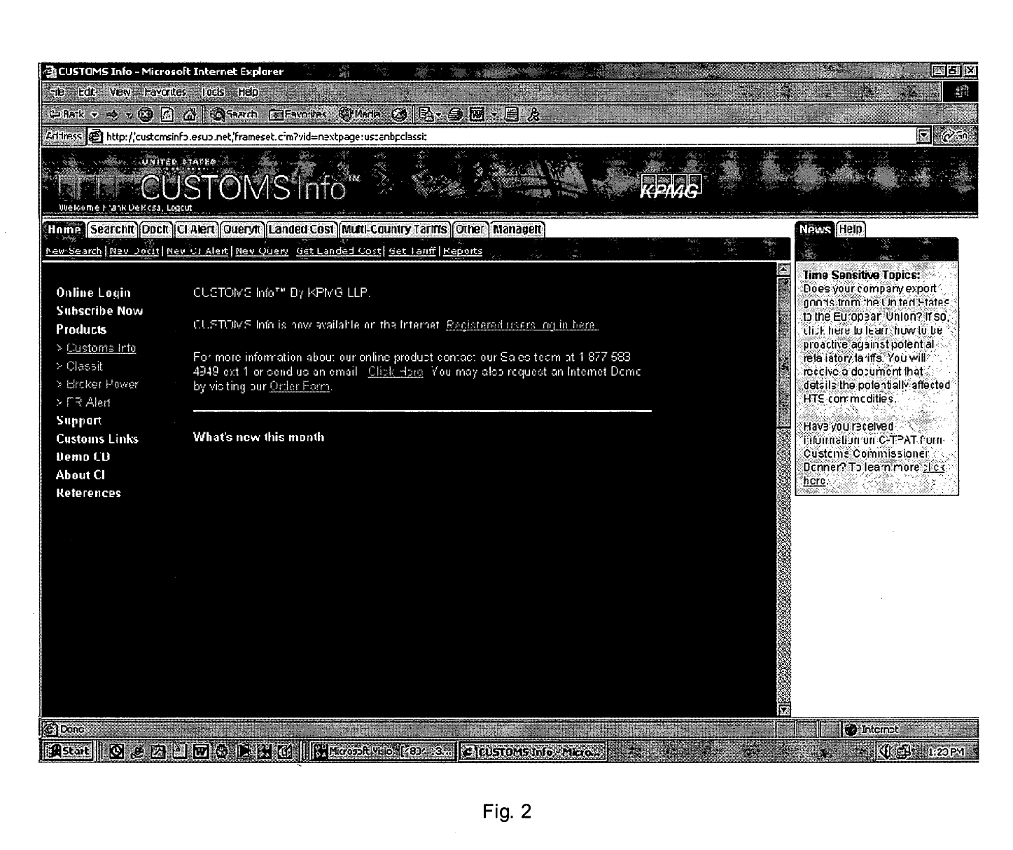

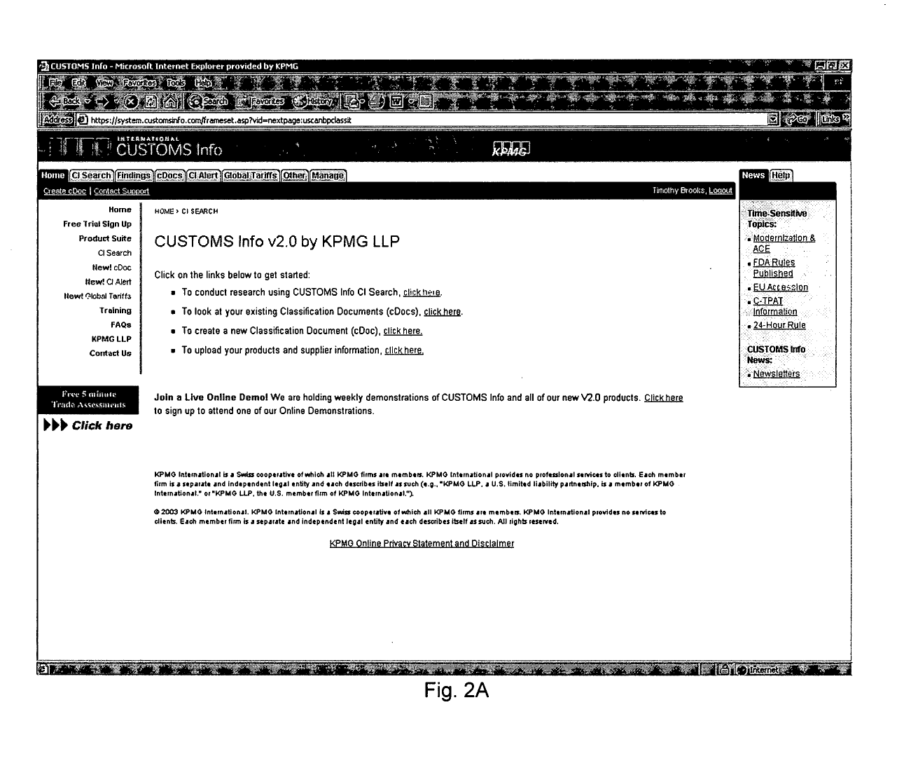

FIGS. 2 and 2A depict screens showing a home page for the System 10 from which the functionality identified in the menu bar may be selected using a mouse click, including “Searchlt” or “CI Search” for searching the database(s) containing the customs related information, DOCIT/cDocs, “ClAlert” for creating an alert, “Querylt” for creating queries relating to quotas, agency requirements, duties, taxes and other information relating to a tariff classification or certain merchandise, etc., Landed Cost, “Multi-Country Tariffs” (also referred to as “Global Tariffs,”) “Other” (discussed below) and “Managelt” or “Manage” relating to System administration by originators and originator companies, e.g., adding authorized users, etc. As described herein, the terms “Searchlt” and “CI Search,” are used in reference to System search functionality and may be used interchangeably. The terms “Multi-Country Tariffs” and “Global Tariffs” are used herein interchangeably to refer to functionality to obtain tariff information for merchandise. “Managelt” and “Manage” are used herein to refer to System administration functionality and may be used interchangeably.

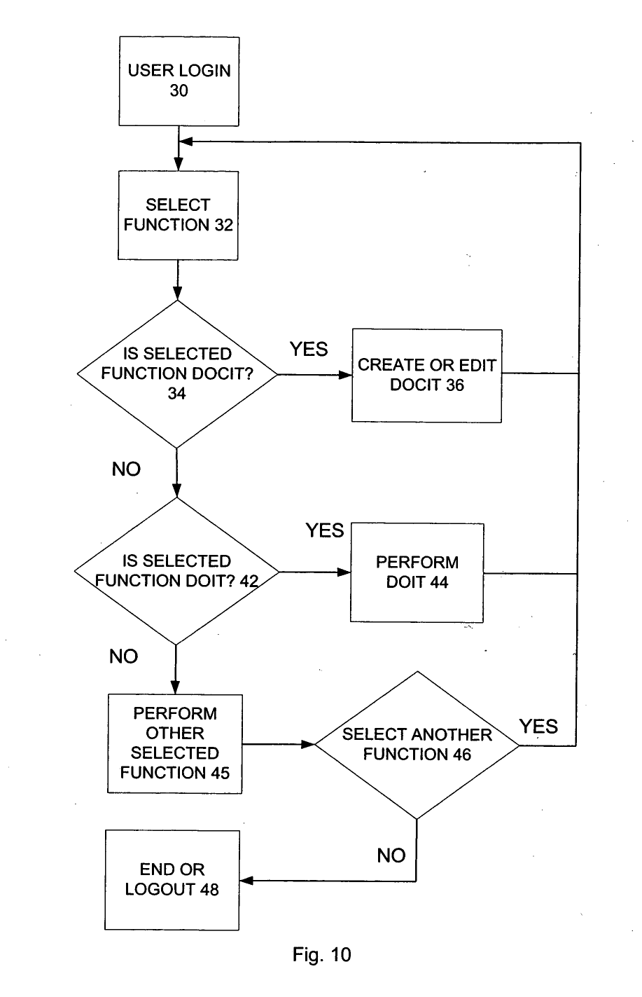

FIG. 10 depicts process flow for System operation. After login (block 30), a function is selected in block 32 (e.g., from the home screens depicted in FIGS. 2 and 2A). If the selected function is DOCIT/cDocs or DOIT/grab (block 34 and 42, respectively), the selected function is performed in block 36 for DOCIT/cDocs and block 44 for DOIT/grab, after which another function may be selected in block 32. Functions other than DOCIT/cDocs and DOIT/grab are performed in block 45. A session represented by the flow chart depicted in FIG. 10 ends with a logout (block 48) or the expiration of a given time period (“End” in block 48) during which no function is selected (loop including blocks 46, 32, 34, 42 and 45) or no function is pursued.

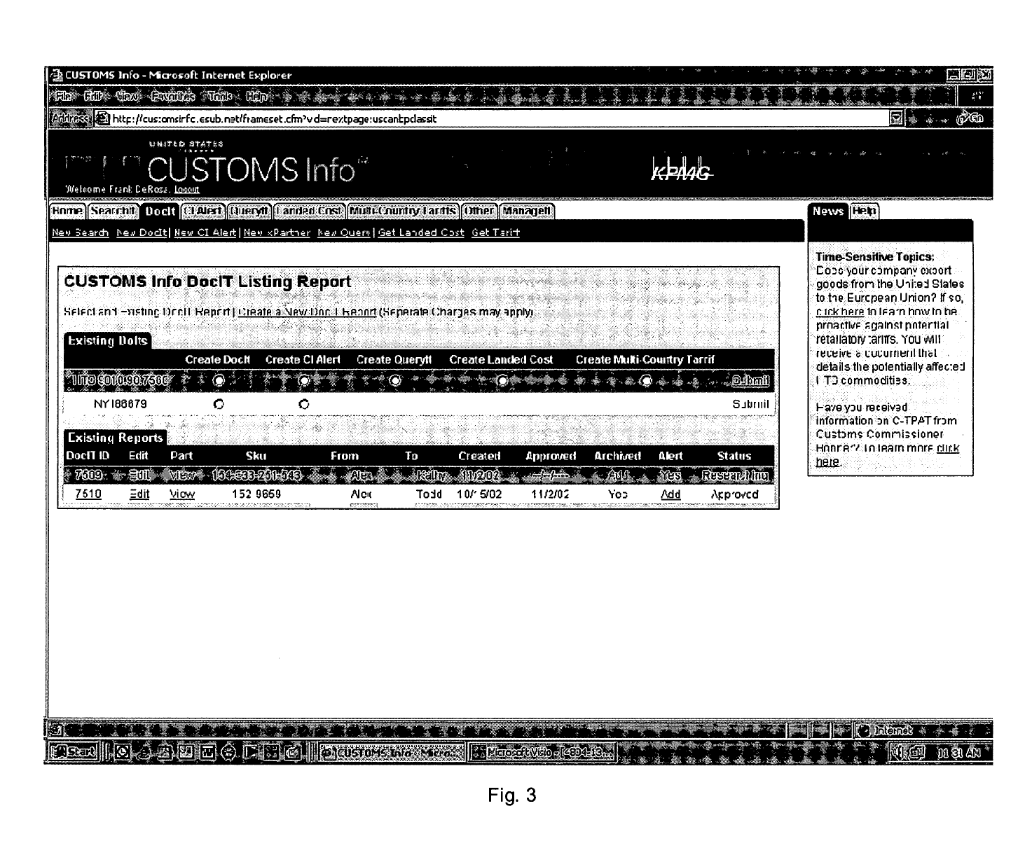

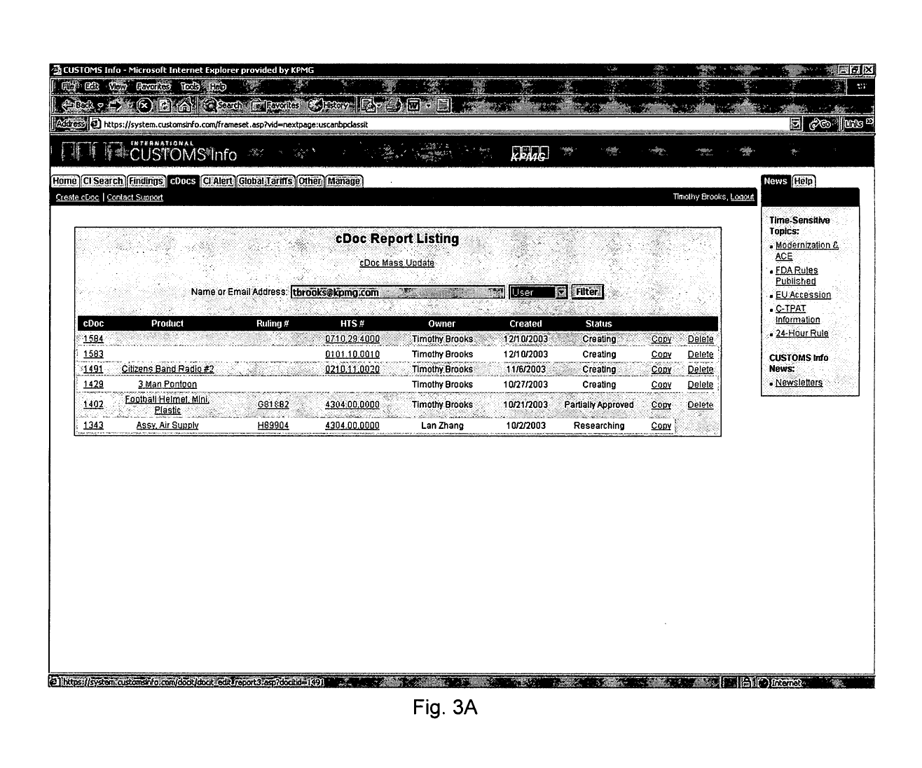

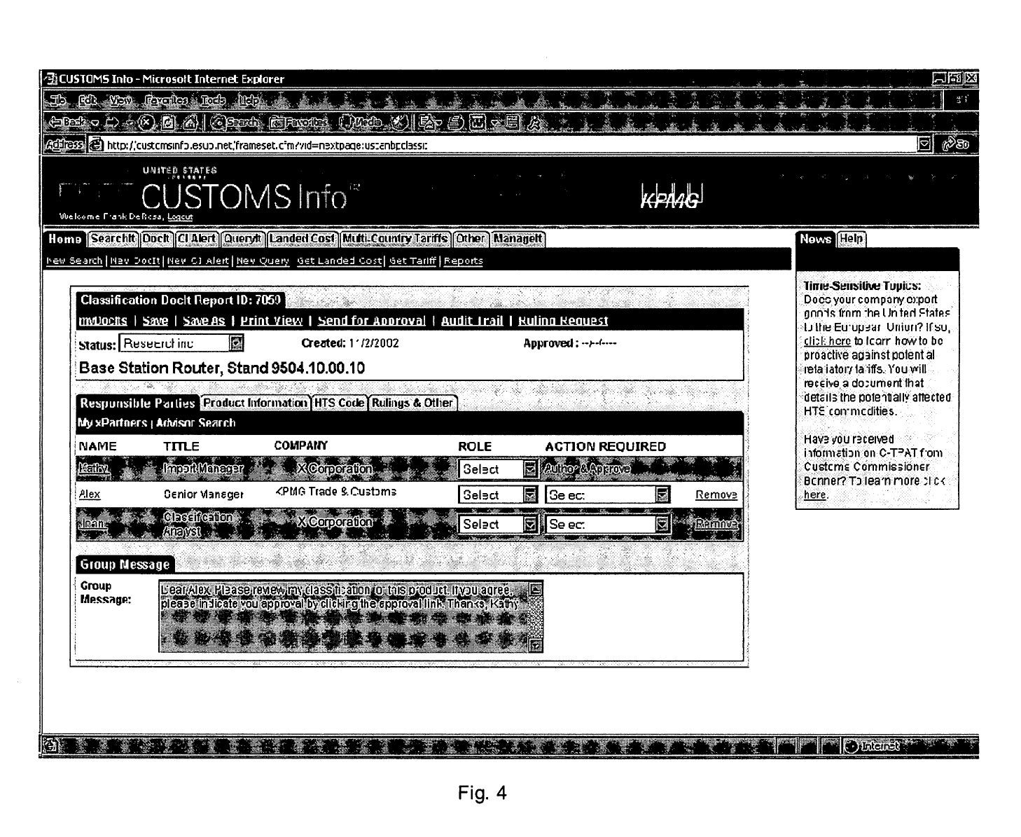

Referring to FIGS. 2, 2A and 10, after user login, represented by block 30 in FIG. 10, a new DOCIT/cDocs is created by selecting “DOCIT/cDocs” or “New DOCIT/cDocs,” in the screen depicted in FIG. 2. Selecting “DOCIT/cDocs” in FIGS. 2 and 2A causes the screen depicted in FIGS. 3 and 3A to be displayed. Selecting “Create a New DOCIT/cDocs” or “Create DOCIT/cDocs” and “Submit” in the screens depicted in FIGS. 3 and 3A causes the screens depicted in FIGS. 4 and 4A to be displayed, where a new DOCIT/cDocs is created, as represented by block 36 in FIG. 10. In some embodiments, a new DOCIT/cDocs may be created by copying an existing DOCIT/cDocs to obtain data or other information relevant to a new DOCIT/cDocs, e.g., participants, classification information, source information or other information related to merchandise, and renaming the copied DOCIT/cDocs for storage as a new file.

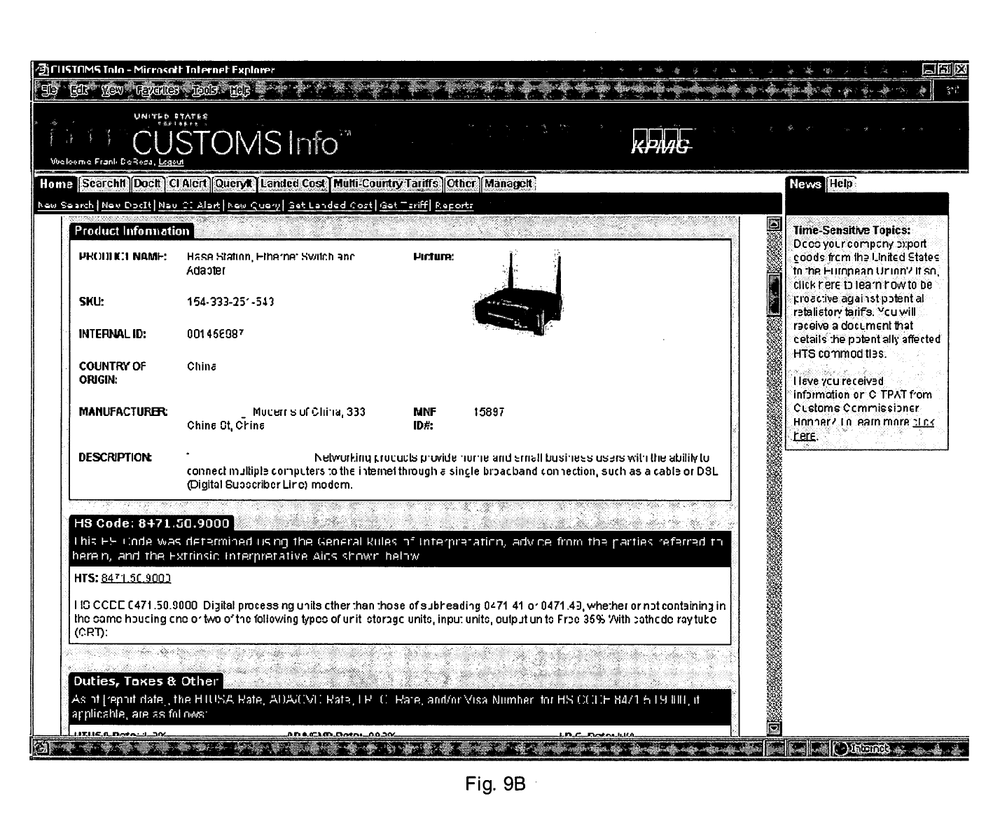

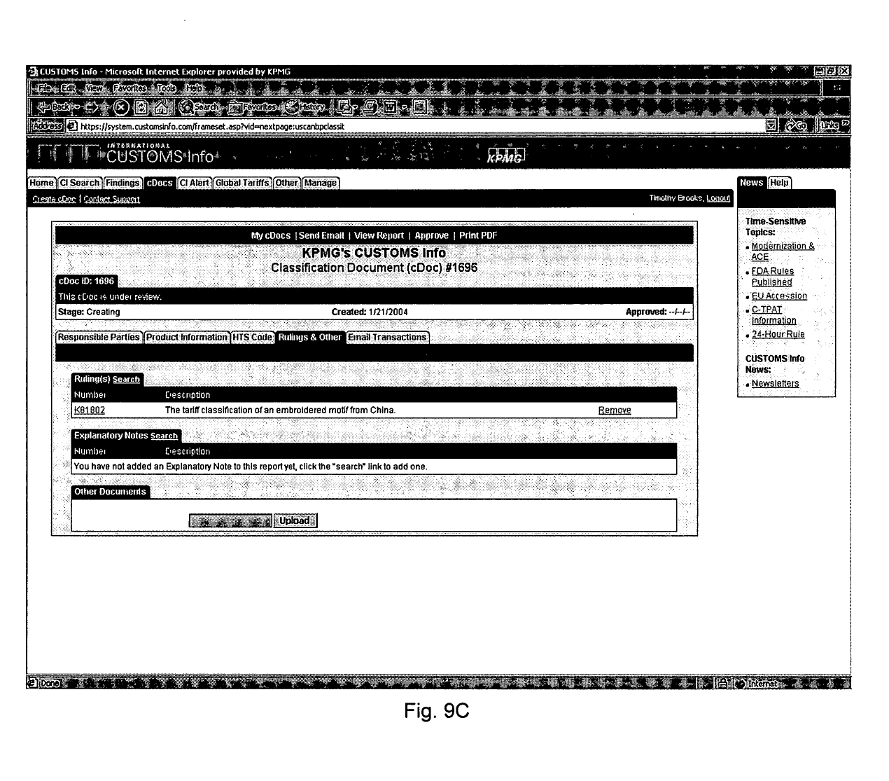

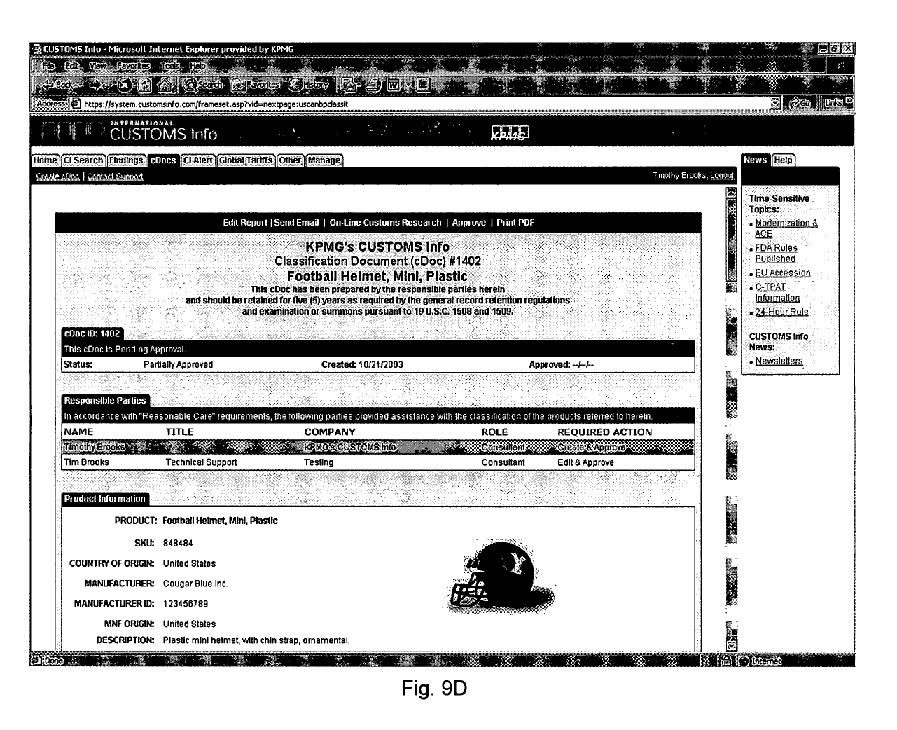

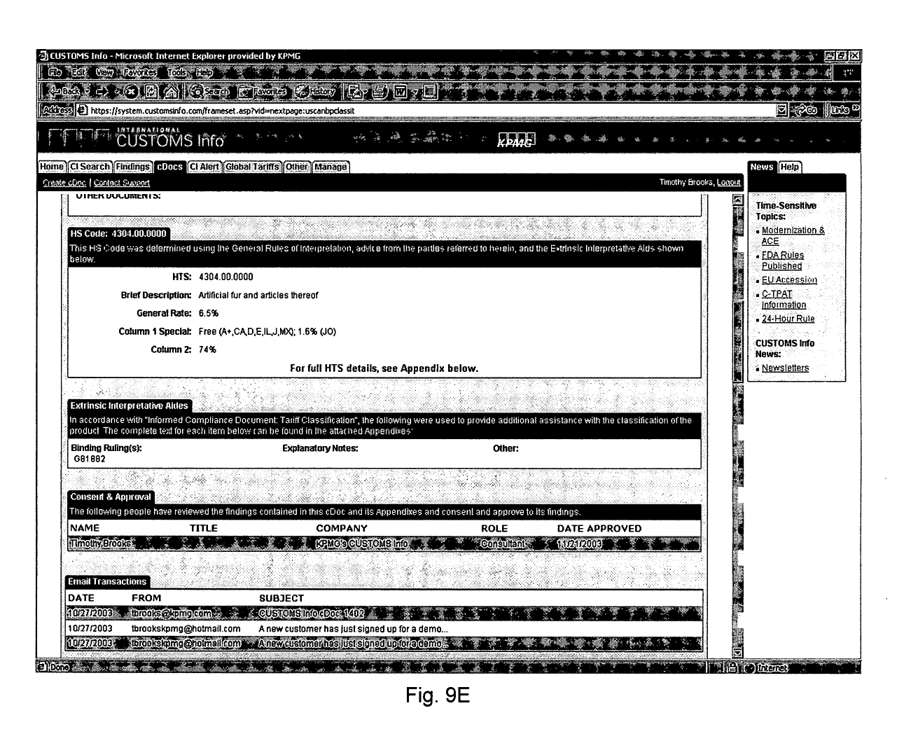

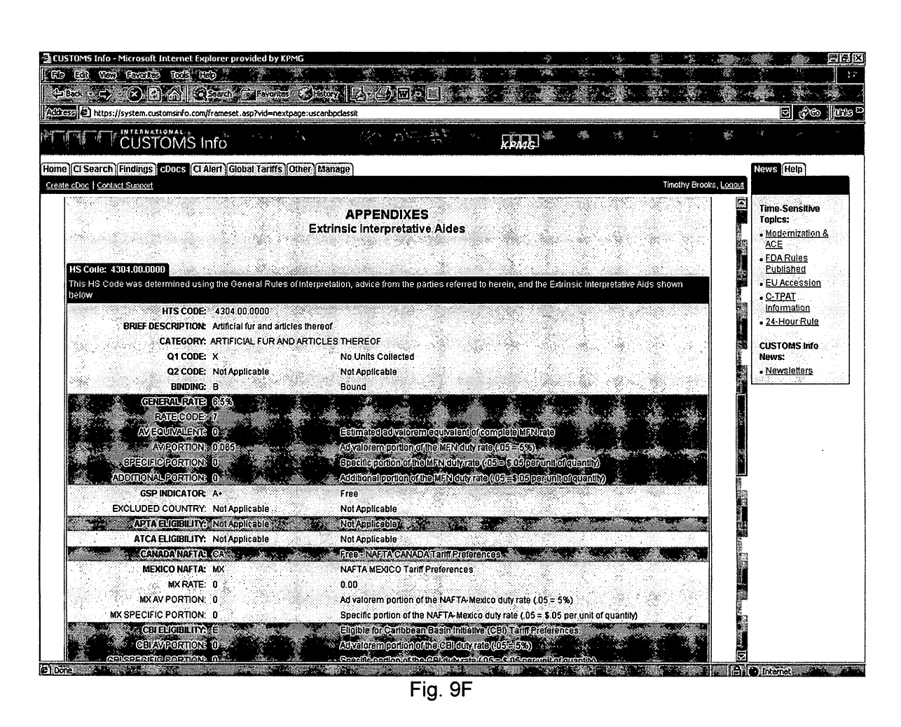

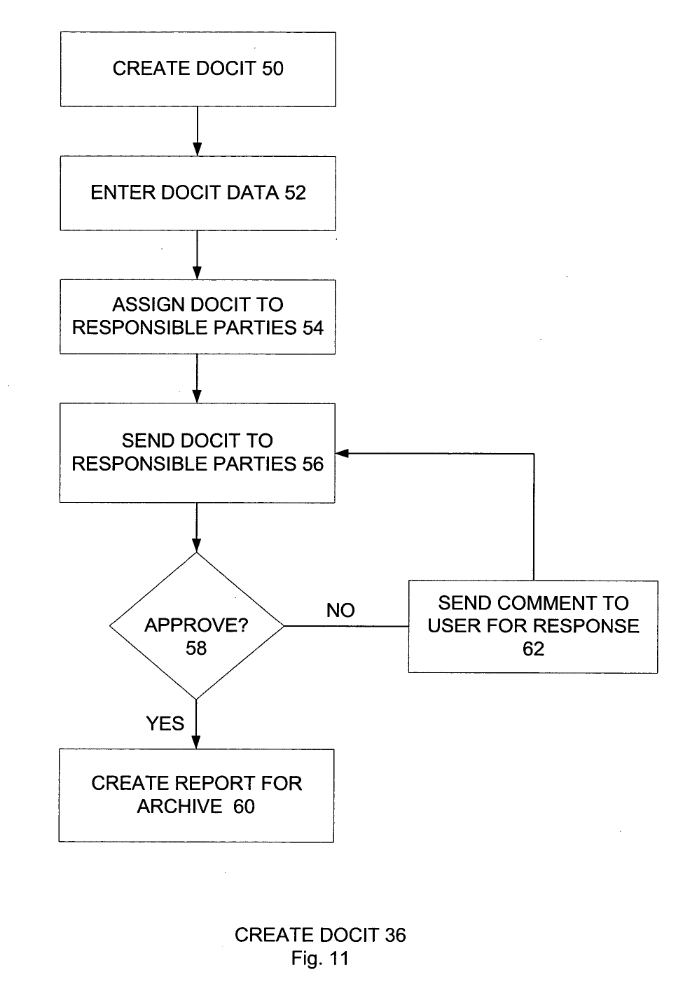

The DOCIT/cDocs functionality represented by block 36 in FIG. 10 is flowcharted in FIG. 11. Referring to FIGS. 4, 4A and 11, in creating a DOCIT/cDocs, an originator enters DOCIT/cDocs data into the screens shown in FIGS. 4 and 4A, as represented by block 52 in FIG. 11, by selecting on the screen, or mouse clicking tabs and buttons for each data type (“My Responsible Parties,” “Advisor Search,” Product Information,” “HTS Code,” “Rulings and Other,”) and entering the respective data. Alternatively, the user may import or upload necessary or useful information from an external source. The DOCIT/cDocs data is generally data related to merchandise, including data types such as: the merchandise name, product information, SKU number, photographs of the merchandise, other documentation, such as brochures related to the merchandise, specifications, manufacturer information, country of origin, HTS classification information, extrinsic interpretive aids, such as rulings, court cases and regulations or other documents accessed or obtained via the invention and associated with the merchandise as shown in the DOCIT/cDocs Report section entitled Product Information of FIGS. 9B and 9C.

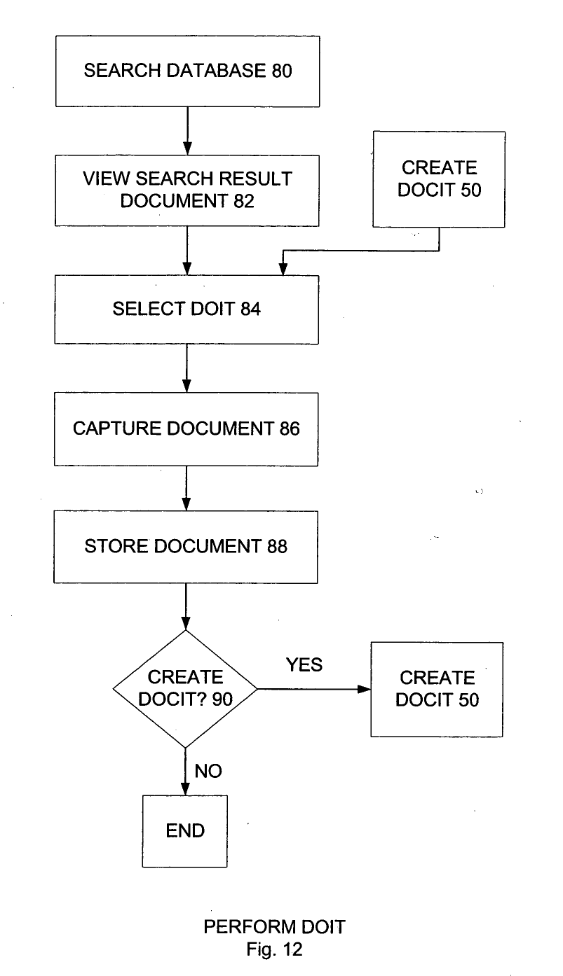

Some of the entered DOCIT/cDocs data (block 52 in FIG. 11) may be identified, for example, as described below, in a database search of database(s) 24 containing the customs-related information described herein, as represented by block 80 in FIG. 12. The merchandise's HTS classification information may also be found by searching the customs-related database(s) 24 and may serve as a basis for creating the DOCIT/cDocs.

The DOCIT/cDocs data may be used for a customs ruling request. Selecting the “Ruling Request” menu button on the screen depicted in FIG. 4 automatically generates a customs ruling request, based upon the DOCIT/cDocs data, for submission electronically or by other means to CBP in accordance with CBP ruling request procedure.

Responsible parties are added to a DOCIT/cDocs by entering the responsible parties' information in the screens depicted in FIGS. 4 and 4A, for example, NAME, TITLE, COMPANY, email address, ROLE, and ACTION REQUIRED, as represented by block 52 in FIG. 11. The action required is generally “approve” or “review” of the DOCIT/cDocs and the classification of the merchandise. The responsible parties include, for example, import managers, advisors, importers, brokers, attorneys, accountants and consultants who are involved in determining or approving the HTS classification for the merchandise or otherwise connected to the sale, purchase, and/or importation of the merchandise. The responsible parties may be added by selecting from a user's list of advisors, for example, by selecting the “My Responsible Parties” tab or the “Advisor Search” tab on the screens depicted in FIGS. 4 and 4A. The “My Responsible Parties” list may comprise advisors used in previous transactions, and/or new advisors added to the list by inputting either the new advisor's electronic mail address, name, specialty or geographic locale into the System, and/or by importing or uploading a user's personal advisor list from an external source. The System automatically sends an electronic mail message to a new advisor inviting the new advisor to use the Service. The “Advisor Search” tab leads to a searchable database 24 of advisors subscribing to the Service.

While it is generally unnecessary to require a System subscription to obtain some or all of the functionality described herein, such as the search function, System registration or subscription is useful to manage or administer the System. For example, requiring non-System users to register/subscribe to the System in order to view and take action on their client's DOCIT/cDocs, or on their own DOCIT/cDocs, or adding new advisors to a “My Responsible Parties” list increases the number of users of the Service. Providing the Advisor Search facilitates identification of advisors in a particular geographic location, and/or experienced in specific types of merchandise, that may become authorized users of the Service. Requiring either an advisor or an originator to pay for the advisor's use of the Service and increasing the number of users increases revenues from subscription fees and use charges and from advertising. (Advertising and news are shown on the upper right corner of FIGS. 2-9.)

After completion of data entry and assigned parties into the DOCIT/cDocs, as represented by blocks 52 and 54 in FIG. 11, the particular DOCIT/cDocs is saved and is accessible under the assigned DOCIT/cDocs reference. Created DOCIT/cDocs are summarized in the screens depicted in FIGS. 4 and 4A, or the screen depicted in FIGS. 3 and 3A obtained by selecting “DOCIT/cDocs” in the menu bar of the screens depicted in FIGS. 2-9. Selecting “Edit” under “Existing Reports” in the screens of FIG. 3 provides the screen of FIG. 4, from which further action with respect to a created DOCIT/cDocs may be provided such as “Save,” “Save As,” “View Report,” Send for Approval,” “Audit Trail,” and “Ruling Request,” per the menu bar under “Classification DOCIT/cDocs Report ID: 7050” of FIG. 4. A status, (e.g., creating, researching, partially approved, or approved) is displayed for each DOCIT/cDoc in the screens depicted in FIGS. 3 and 3A. Preferably, status information for all DOCITs/cDocs may be obtained by authorized users.

Selection of the “Send Email” link on the screen depicted in FIG. 4 sends the DOCIT/cDocs to the responsible parties, as represented by block 56 of FIG. 11, and automatically distributes messages to the responsible parties and/or other appropriate parties by electronic mail, or other means of communication, containing reference to the DOCIT/cDocs, and their respective assigned required action. In preferred embodiments, the responsible parties and/or other recipients of the message, must log into the System to view, edit, consent, research or approve the DOCIT/cDocs, which may be identified entering either the DOCIT/cDocs reference and/or the responsible party's user name, HTS, part number, etc.

The required actions, if any, of the responsible parties may be tracked. The responsible parties and/or other recipients of the message may undertake and complete their assigned task by inputting their action into the DOCIT/cDocs (FIGS. 3, 3A, 4 and 4A), or in preferred embodiments, may use electronic signatures to identify themselves in connection with the action taken. The originator may designate authority to each or some of the responsible parties to amend the DOCIT/cDocs, or limit write-access to the DOCIT/cDocs to the user alone.

If the responsible parties do not approve the DOCIT/cDocs, as represented by block 58 in FIG. 11, a responsible party may send his or her comments to the originator for response, as represented by block 62. Generally there will be some communication back and forth between the originator and responsible parties (researching status) regarding the classification determination before the responsible parties approve the DOCIT/cDocs (questions & answer with approval status) in block 58, or otherwise completes their assigned tasks. Each of the communications between the user and a responsible party are tracked and selected for storage in association with the DOCIT/cDocs.

Upon approval by the responsible parties, a Report is automatically compiled for archive, as represented by block 60. Two sample Reports are depicted in FIGS. 9A-9B and 9C-9F. All information and documents referenced in or stored in connection with a DOCIT/cDocs may be stored in a read-only document format, for example in PDF, XML, or HTML, which can not be changed in storage after completion, for each DOCIT/cDocs, including the DOCIT/cDocs data, for example: the identities of the responsible parties, his or her decisions and actions taken, if any, by chronology and/or the responsible parties including an electronic signature signifying the responsible parties' approval with his or her own action or determination; the HTS classification for the merchandise; the description with index and full text of supporting classification documentation relied upon by the responsible party in making his or her determination or performing his or her action; product information; and associated duties, taxes and costs for the merchandise. The Reports (FIGS. 9A-9B and 9C-9F) are distributed to the responsible parties electronically or through other communication means, such that the recipients may store the Report locally, and/or archived in the network-accessible storage for a preset time (e.g., for at least five years), in compliance with United States customs law and regulations (19 U.S.C. § § 1508 and 1509, 19 C.F.R. § 163.4), and laws of other countries, such that it will be accessible to the authorized users at any time during the five year period and may serve for recordkeeping purposes, and to provide an audit trail. Fees may apply for storage.

The archive feature of the invention facilitates and captures informed compliance processes, which makes classification and entry documentation accurate and reliable, and provides evidence of “reasonable care” without requiring hardcopy storage needs. The DOCIT/cDocs history is easily retrievable for general use and/or at the request of a customs official. The Report and any document stored in association therewith may be accessed in known manner based on stored information, e.g., identified in the database schema shown in FIG. 13.

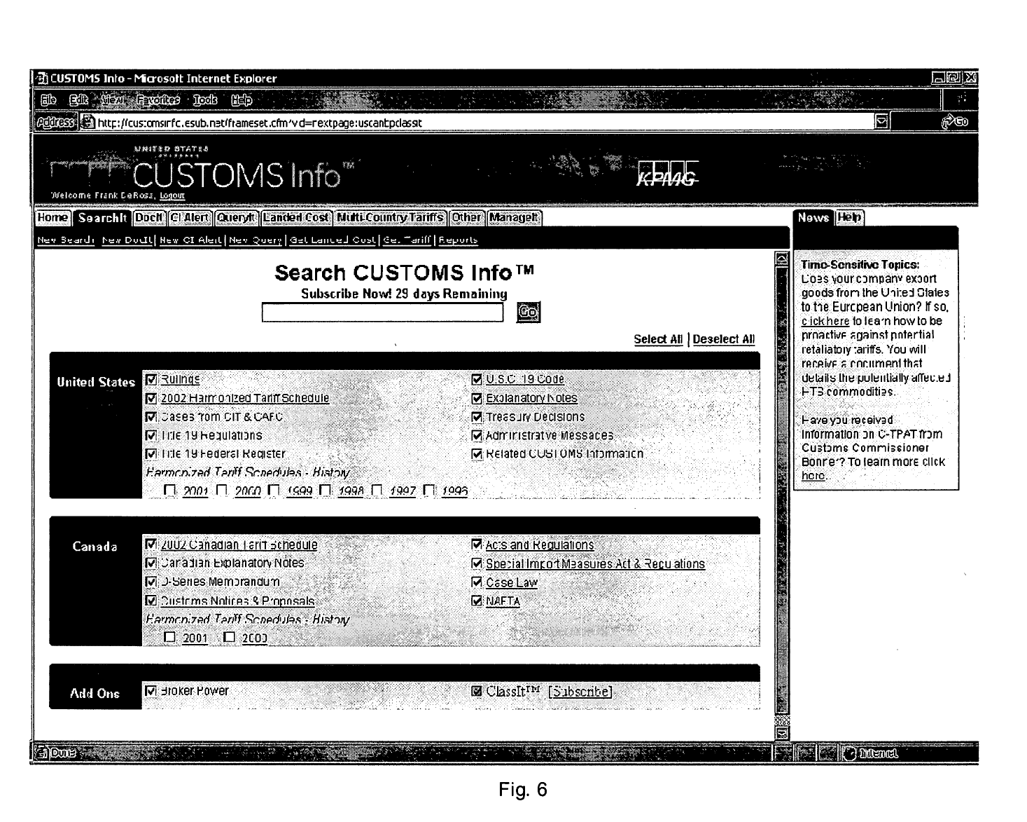

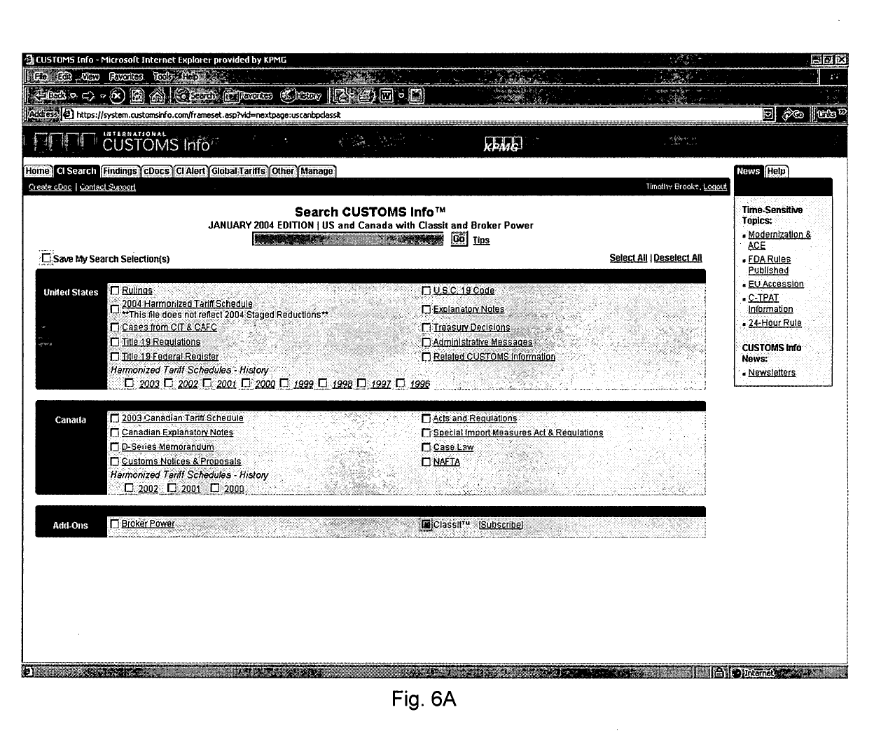

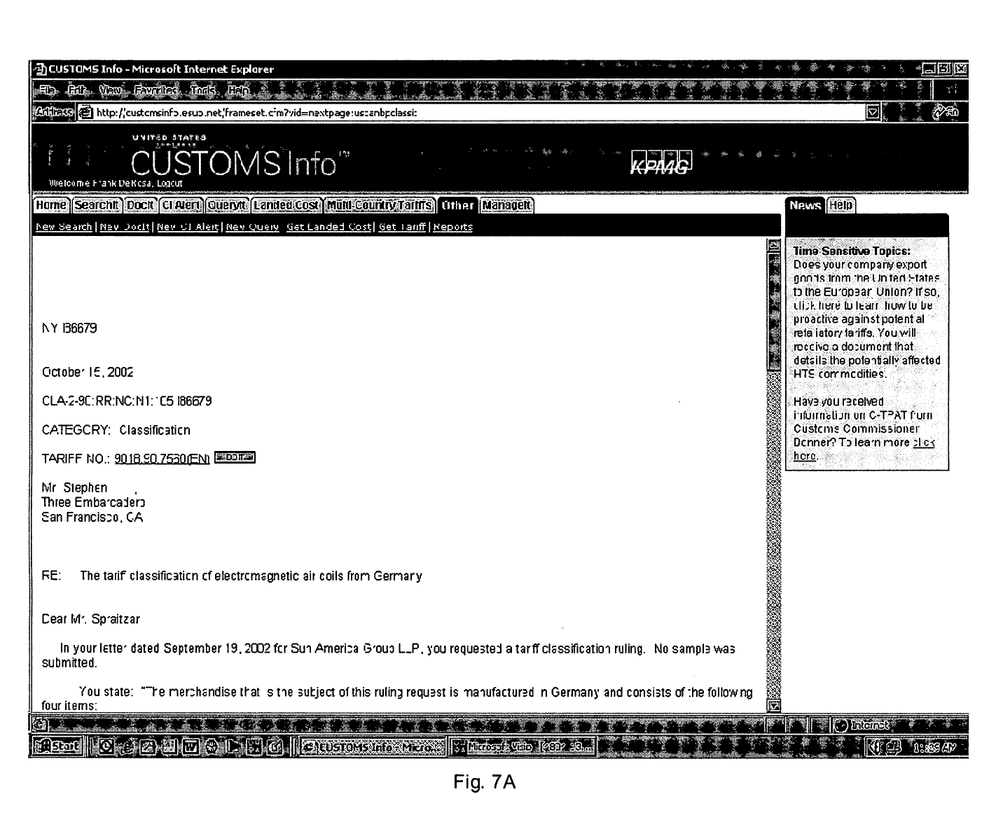

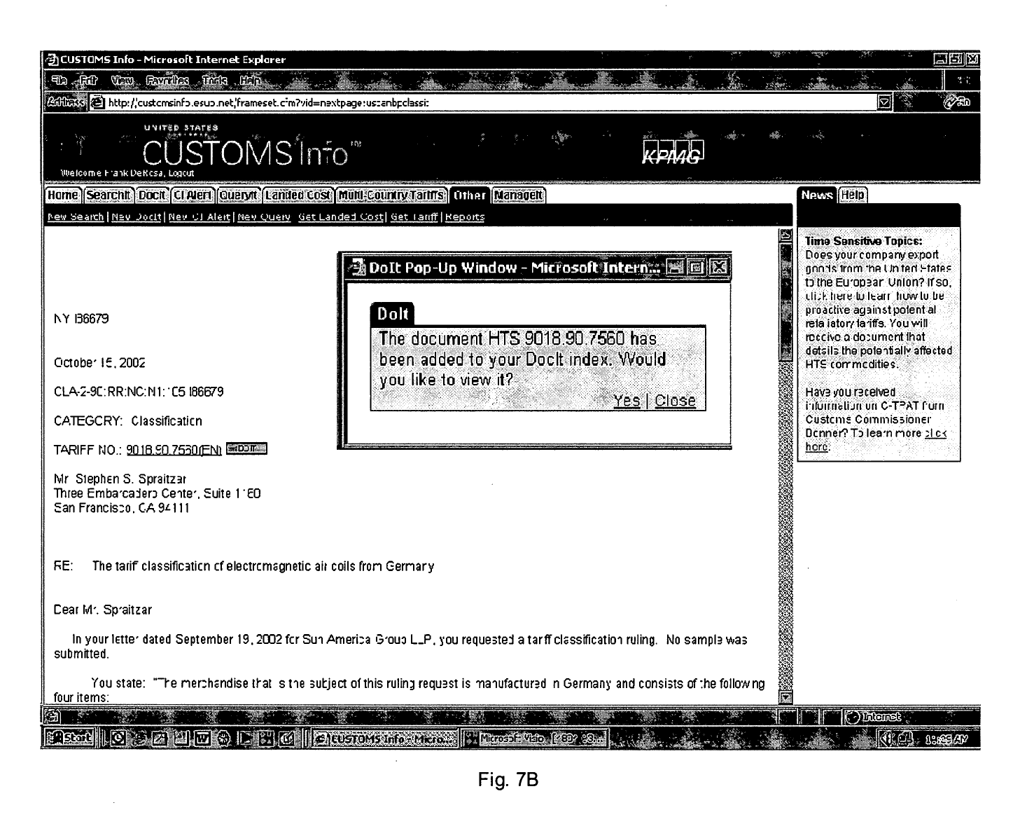

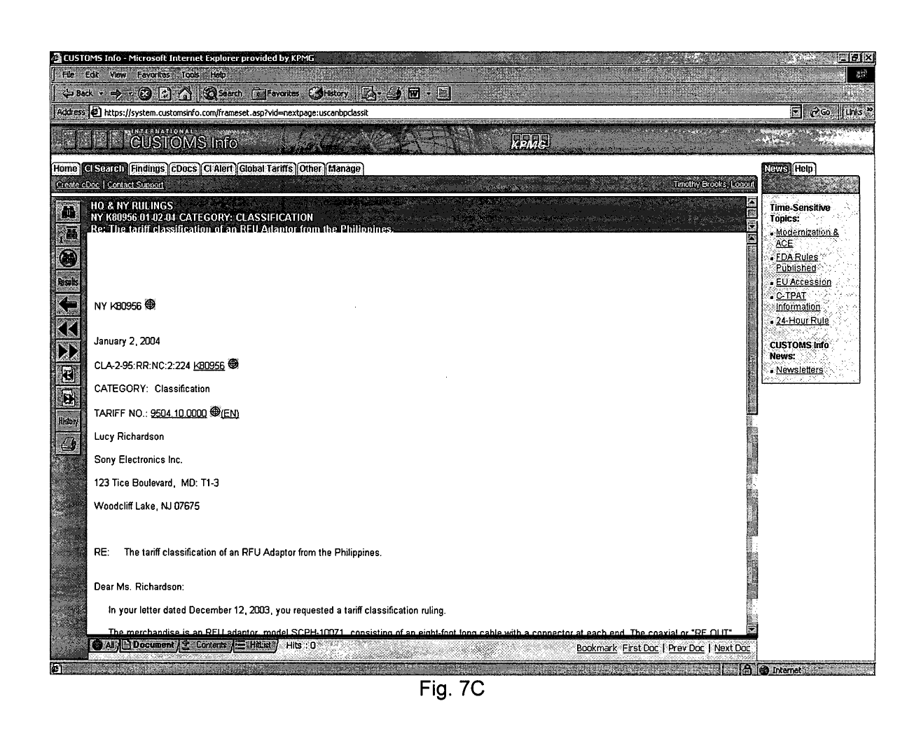

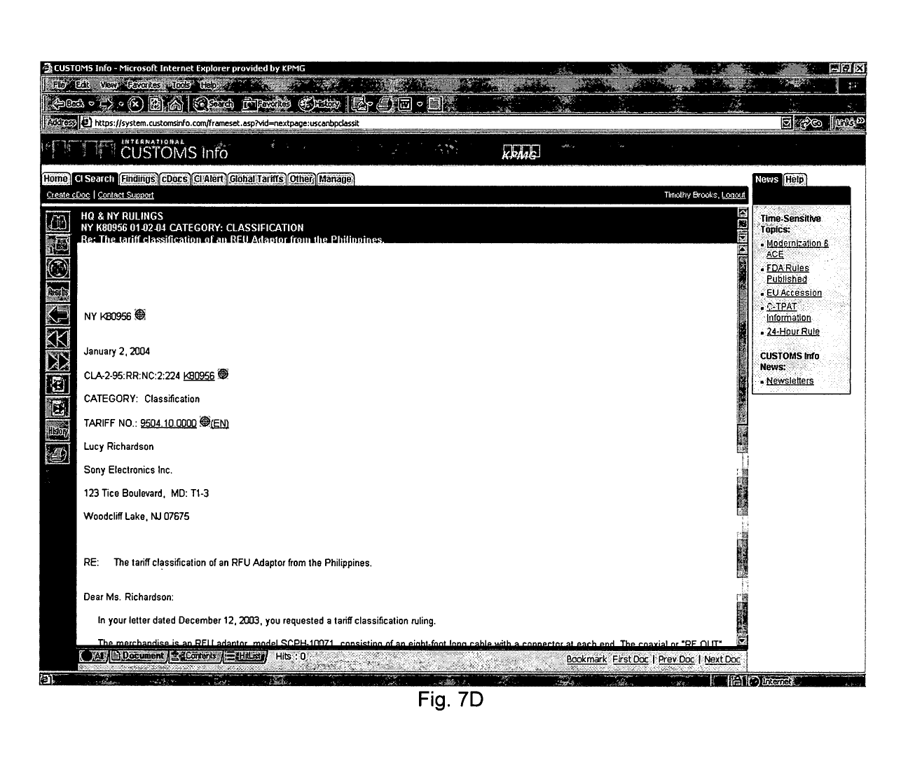

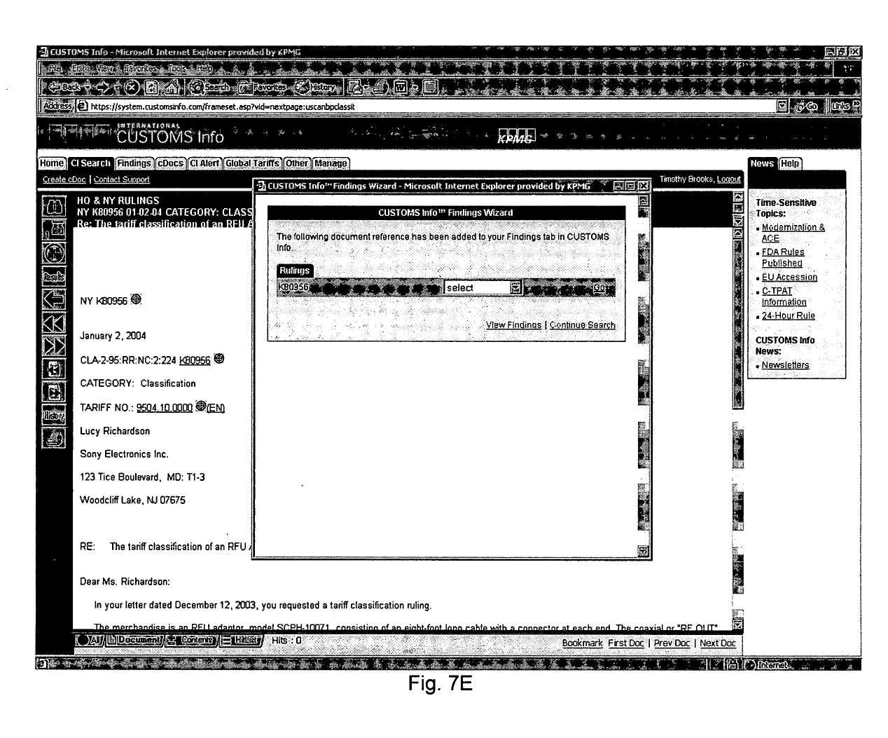

The DOIT/grab function is described with reference to FIGS. 6, 6A, 7A-F, 10 and 12.

The DOIT/grab function may be activated from the search function, or from the DOCIT/cDocs function. As discussed above, the DOIT/grab function in a preferred embodiment initially stores links to documents selected from a search or otherwise, but may store the documents themselves in the same or a form different from that stored by the DOCIT/cDocs function. The DOIT/grab function may be performed alone, or prior to or after creation of a DOCIT/cDocs. If the DOIT/grab function is performed alone, or prior to creation of a DOCIT/cDocs the selected information is stored, in association with the user, e.g., in the user's Existing DOIT/grab list summarized in FIG. 3. If a user's subscription rate includes database searches, performing a DOIT/grab function will generally trigger a transaction or event, which may or may not trigger a fee. However, performing additional functions based upon information selected using the DOIT/grab function will generally trigger fees.

Referring to FIG. 12, which flowcharts performance of the DOIT/grab function represented by block 44 in FIG. 10 in connection with a search, a user searches customs-related database(s) 24, as represented by block 80, by selecting the “Search” function on the menu bar on any of the screens depicted in FIGS. 2-9, which causes the screen depicted in FIG. 6 to be displayed. From the screen depicted in FIG. 6, a user may search the entire or any specific dataset within customs-related database(s) 24 using well-known search methods such as common term keywords, database limiters, and/or Boolean logic to search databases selected from the FIG. 6 screen, e.g., “Rulings,” “2002 Harmonized Tariff Schedule,” etc. The search results are displayed on a screen from which hit documents may be selected for viewing, as represented by block 82 in FIG. 12. Hit documents contain, in addition to the text of the document, a DOIT/grab link, and hyperlinks to any references within the document, including for example, rulings, classification codes, World Customs Organization explanatory notes, court cases and/or regulations. The hyperlinks for each of the references may be selected by the user to view the referenced document. Each screen which displays a hit document includes a “DOIT/grab,” link or bulls eye, e.g., as shown in the screens depicted in FIGS. 7A and 7B and FIGS. 7C-E. Selecting the “DOIT/grab” link or bulls eye, as represented by block 84 in FIG. 12, captures the displayed document or information, as represented by block 86, and causes the pop-up screens depicted in FIGS. 7B or 7F to be displayed. Selecting “Close” on FIG. 7B causes the pop-up screen to close. Selecting the links in FIGS. 7B and 7F allows a user to add DOIT/grab information to an alert, e.g., to create an alert, such as “CIAlert,” further described herein, or obtain other functionality, e.g., obtaining merchandise classification information, such as a multi-country tariff code, for example, by using the “Multi-Country Tariff,” function further described herein. Generally, all identifying references to or about the document or its contents and/or related documents, and/or the location of a document or documents within a database, etc., may also be selected. The selected information and/or document are associated with the selecting user in a server or storage device accessible to the selecting user, as represented by block 88. When selecting the DOIT/grab function from a displayed document that contains a plurality of references, the user may specify which specific references within the document the user wishes to capture as opposed to all references. A user can also search for information that appears on a product page, manufacturer page, DOCIT/cDoc listings page, ClAlert listing page or other page or stored data source, to obtain information related to particular merchandise. Generally, search criteria and search results can be stored to the system for access and customization by authorized users. Additionally search results may be exported to a file, e.g., an excel spreadsheet.

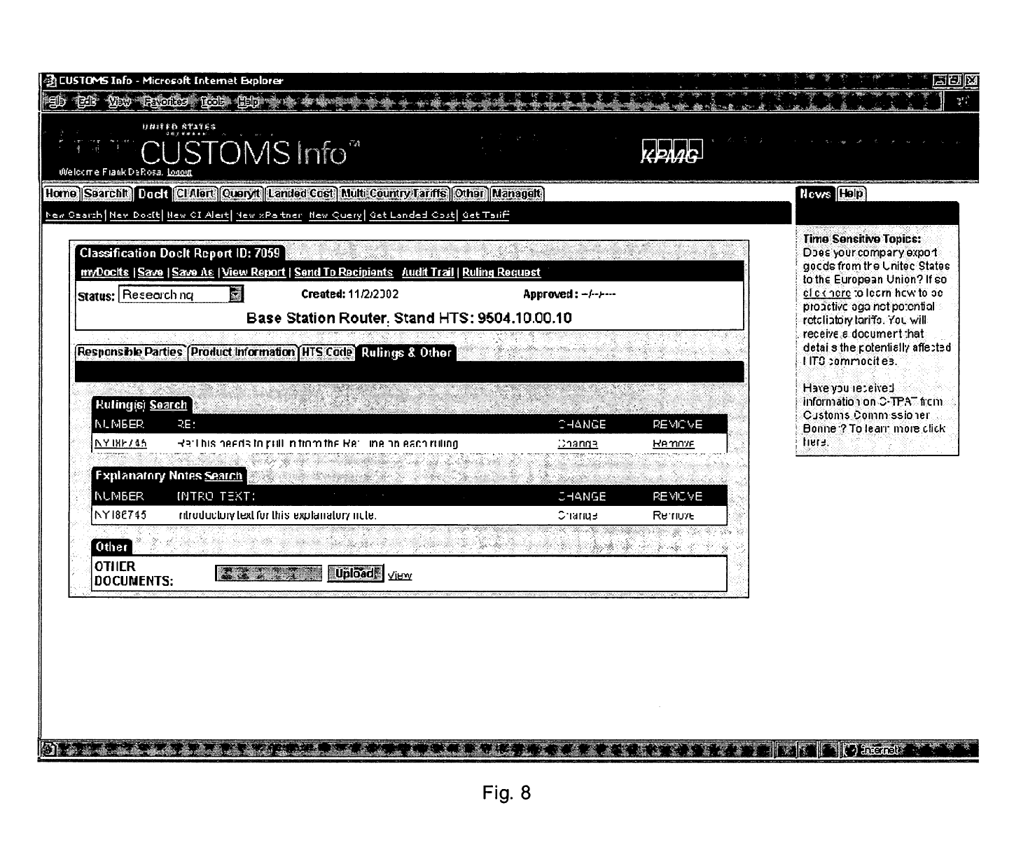

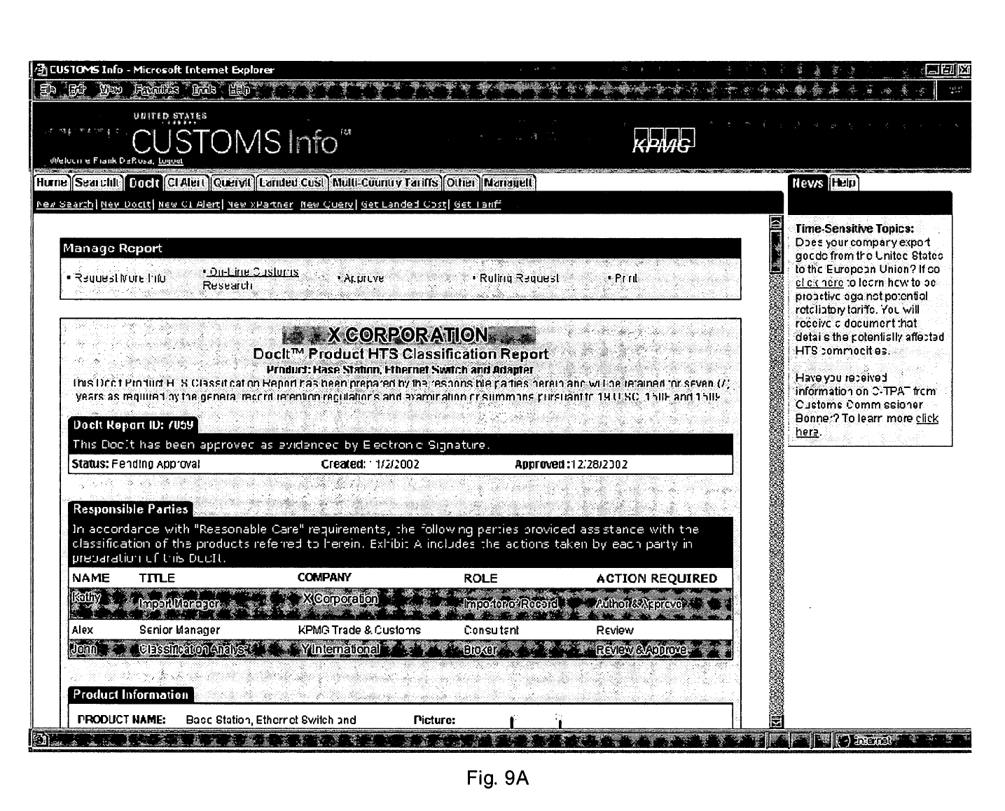

As mentioned previously, the DOIT/grab function may also be activated from the DOCIT/cDocs function, where links to information, etc., may be stored in association with an existing DOCIT/cDocs for a classification determination in progress. This is schematically illustrated in FIG. 12 by the create DOCIT/cDocs block 50 leading to the select DOIT/grab block 84. For example, selecting “Rulings & Other” from the lower menu bar in the screen depicted in FIG. 4 causes the screen depicted in FIG. 8 to be displayed. Selecting the “Other” button at the bottom of this screen enables other documents to be viewed, uploaded and selected for DOIT/grab storage in association with a DOCIT/cDocs.

The DOCIT/cDocs function may also be activated from within the DOIT/grab function, as represented by blocks 50 and 90 in FIG. 12. For example, when the DOIT/grab function is selected for any document found in a search, a resulting screen includes the option to select DOCIT/cDocs (block 90), for example from the screen of FIG. 3, in association with which the selected DOIT/grab document will be stored.

Each of the DOIT/grab references and/or documents, depending on type, may be used as a basis for selecting additional functions. The types of documents or references captured (block 86 in FIG. 12) could be for example an HTS code, or a ruling, for which, only the HTS code is capable of serving as a basis to create a new DOCIT/cDocs, CIAlert, Querylt, Landed Cost Estimate, and/or a Multi-Country Tariff. On the other hand, a ruling could serve as a basis to create only a new DOCIT/cDocs, and/or CIAlert. Automated intelligence in the System limits functions that can be performed in accordance with the type of document captured.

Using a stored document as a basis for creating a DOCIT/cDocs hastens creating a DOCIT/cDocs by reducing the necessary data items the user enters into the DOCIT/cDocs because the stored document references are automatically associated with the DOCIT/cDocs at the time the DOCIT/cDocs is created and therefore will be included in the DOCIT/cDocs before the user begins entering DOCIT/cDocs data.

Other functions may be accessed as discussed above illustrated by the flow chart depicted in FIG. 10 (blocks 32, 45 and 46). These other functions include “CIAlert,” “Querylt,” “Landed Cost,” and “Multi-Country Tariff,” as represented on the menu bar of any of the screens depicted in FIGS. 2-9.

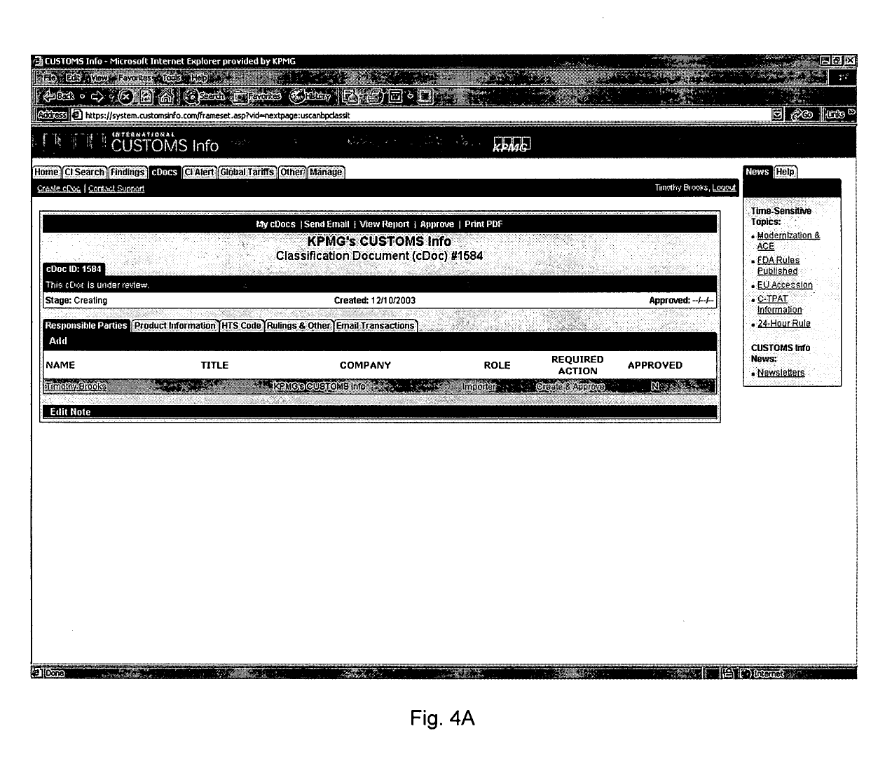

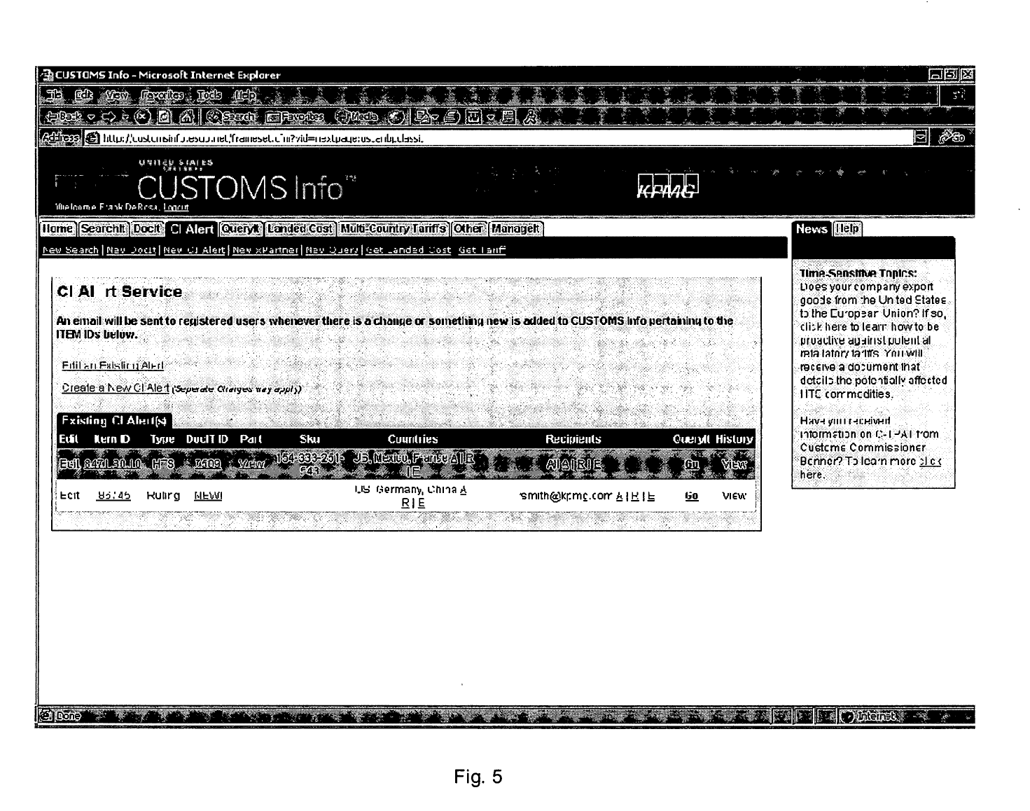

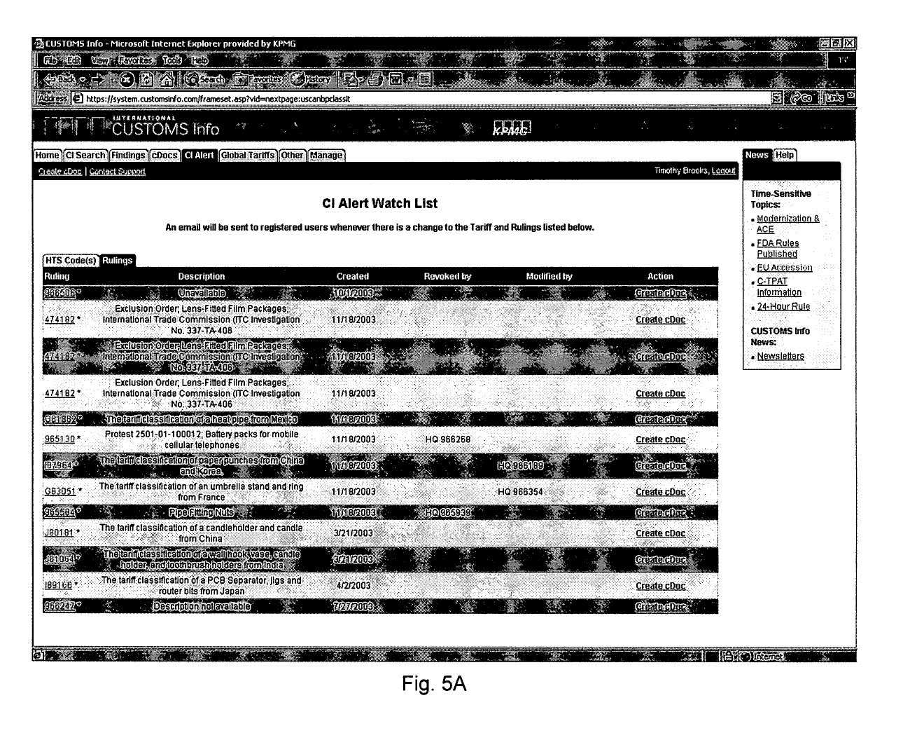

The CIAlert function notifies a user or users of changes related to any reference, for example, a classification code, ruling modification or revocation, entered into the particular alert on the screen depicted in FIGS. 5 and 5A. One of the benefits of CIAlert is that a user or users are notified of issues or problems, e.g., the possibility of detention of merchandise at the time of entry, that may arise as a result of inaccurate information related to merchandise stored in a DOCIT/cDocs. Data may also be automatically entered to create a CIAlert through a DOIT/grab as previously discussed above. When new data from any source is added to the database(s) 24, the System 10 scans each data item as it is added to the database(s) 24 and searches for changes affecting the classification of merchandise or any reference entered in the alert. If a new data item is added to the database(s) 24 that affects or otherwise pertains to the user entered reference in an alert, designated recipients are automatically notified of the new data item via electronic mail, or other means of communication, and informed of any new data item indicating a change, which may affect the reference. The alert function may be selected from the menu bar on any of the screens depicted in FIGS. 2-9. Data that can be entered into an alert includes relevant “Countries,” alert “Recipients,” the product “SKU,” the product “ID,” and “Type.” The history of an alert may be viewed by selecting the “View” tab on the screens depicted in FIGS. 5 and 5A.

The Querylt function provides information related to quotas, visas, other agency requirements, other duties, e.g., antidumping, countervailing, and/or taxes or other regulatory limits on certain merchandise. The user may select the Querylt function in connection with the Existing DOIT/grabs shown in the screen depicted in FIG. 3 such that the Existing DOIT/grab data related to the merchandise's HTS code and country automatically populates a search query to search the database(s) 24 for any quota or regulatory limit on importing the specific merchandise. A report is automatically generated by the System containing information related to the query which may be viewed on a subsequent screen, or sent to the user by electronic mail, or other means of communication. Alternatively, the report may be stored in association with a DOCIT/cDocs or used as a basis for creating a DOCIT/cDocs.

The “Landed Cost Function” provides information related to the estimated landed cost of a certain merchandise. The user may select the Landed Cost Function in connection with the Existing DOIT/grabs shown in the screen depicted in FIG. 3 such that the Existing DOIT/grab data related to the destination country and the merchandise's HTS code automatically populates a search query to search the database(s) 24 for the landed cost for importing the specific merchandise. A landed cost evaluation may also be obtained by manually entering information related to merchandise that is separate from data stored in association with an existing DOIT.

A report is automatically generated by the System containing information related to the estimated landed cost which may be viewed on a subsequent screen, or sent to the user by electronic mail, or other means of communication. Alternatively, the report may be stored in association with a DOCIT/cDocs or used as a basis for creating a DOCIT/cDocs.

The Multi-Country Tariff function provides information related to the tariff for a particular item of merchandise. The user may select the Multi-Country Tariff function in connection with the Existing DOIT/grabs shown in the screen depicted in FIG. 3 such that the Existing DOIT/grab data related to the destination country and the merchandise's HTS code automatically populates a search query to search the database(s) 24 for the multi-country tariff for importing the specific merchandise. A report is automatically generated by the System containing information related to the Multi-Country Tariffs which may be viewed on a subsequent screen, or sent to the user by electronic mail, or other means of communication. Alternatively, the report may be stored in association with a DOCIT/cDocs or used as a basis for creating a DOCIT/cDocs.

In other embodiments, tariff information is obtained by selecting the tab “Global Tariffs” depicted in the screens of FIGS. 3A, 4A, 5A and 6A etc. Global Tariffs functionality allows a user to obtain tariff translations, for example, a user may enter a United States classification code and input a destination country to obtain the corresponding classification code for the destination country and any related tariffs. Global Tariffs functionality allows a user to obtain Landed Cost and do a Landed Cost Comparison.

FIG. 13 is relational database schema for a preferred embodiment of the invention which shows the various entities and associated relationships involved with the functionality described herein.

For example, information related to a user, e.g., individuals, government agencies, companies or other entities, is stored in the “User” entity, which has relationships with the following entities: “Company,” “Registration,” “User Type,” “User Status,” “Security Questions,” “xPartner,” “User Subtype,” “DOIT/grab Select Document,” Transaction Journal,” “Address,” “DOCIT/cDocs Audit Trail,” “DOCIT/cDocs,” “CIAlert,” “CIA Alert Recipient,” “Permission” and “User Role”. Similarly, the “DOCIT/cDocs” entity has relationships with the “User” entity, the “DOCIT/cDocs Archive” entity, to name a few. The relationship and storage of data in connection with the functionality described herein will be apparent to those of skill in the relevant art(s) and a detailed discussion thereof is not believed to be necessary for an understanding of the invention(s) disclosed herein. For example, an originator will have the attributes of the “User” entity with relationships to “permission,” “address,” etc. The manner in which information is stored in and accessed from the database represented by FIG. 13 is conventional.

With respect to the inventive methods, authorized persons capable of originating or approving a DOCIT/cDocs or a DOIT/grab function must register, e.g., by way of a subscription, to the Service and may be charged a subscription fee and/or a use fee. By providing for an indication of concurrence or approval and review from persons in addition to originators, the invention increases the number of persons who need access to the Service. In accordance with the invention, such additional persons may be charged a subscription fee, which is the same or less than a registration or subscription fee for an originator, and/or use fees. Subscription fees may be set by levels or classes of users, for example, users associated with government or non-profit organization may be given free access to induce other users to subscribe for a fee. Other levels or classes of users may be categorized based on their connection to the merchandise classification determination, e.g., advisors or experts may be given a different subscription rate than an originator. These fees may be made payable directly by such additional persons, or provision may be made for increases in the fees paid by originators for participation and/or access by such additional persons.

Systems and modules described herein may comprise software, firmware, hardware, or any combination(s) of software, firmware, or hardware suitable for the purposes described herein. Software and other modules may reside on servers, workstations, personal computers, computerized tablets, PDAs, and other electronic devices suitable for the purposes described herein.

Software and other modules may be accessible via local memory, via a network, via a browser or other application in an ASP context, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots presented and described herein can be displayed differently as known in the art to input, access, change, manipulate, modify, alter, and work with information.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

what is claimed is:

1. A method for facilitating importing merchandise into a country, comprising:
inputting data related to at least one item of merchandise;
searching a database of customs-related information to obtain classification information related to the at least one item of merchandise; and
storing the inputted data and the classification information.

2. The method of claim 1 wherein the database of customs-related information includes at least one of product classification, regulations, rulings, directives, registrations, duty notices, foreign codes, tariff schedules, explanatory notes, encyclopedias, and contact directory of customs advisors.

3. The method of claim 1 further comprising:
associating the stored inputted data and classification information with at least one party;
assigning an action to the at least one party related to the inputted data and classification information;
storing the action taken by the at least one party;
generating a report based on the inputted data, classification information, the action assigned and the action taken by the at least one party; and
storing the report.

4. The method of claim 3 comprising searching the database of customs-related information for new data relevant to the classification of the at least one item of merchandise; and notifying the at least one party of the new data identified in the search.

5. The method of claim 3 comprising storing the reports for a preset time.

6. A method for creating a compliance audit trail for importing merchandise into a country, comprising:
inputting data related to at least one item of merchandise;
associating the inputted data with at least one party;
searching a database of customs-related information for information relating the inputted data;
comparing the inputted data to the database of customs-related information to obtain a classification of the at least one item of merchandise based on the inputted data;
sending the inputted data and classification to the at least one party for action;
receiving information related to the action from the at least one party; and
generating a report based on the results of the comparison to obtain classification of the at least one item, and the action of the at least one party.

7. The method of claim 6 comprising storing the reports for a preset time.

8. The method of claim 6 wherein the report comprises tariff product classification.

9. The method of claim 6 wherein the report identifies import duties for the at least one item of merchandise.

10. The method of claim 6 wherein the report provides tracking information for the merchandise.

11. The method of claim 6, comprising searching the database of customs-related information for new data relevant to the classification of the at least one item of merchandise; and notifying the at least one party of new data identified in the search.

12. A method for obtaining subscribers to a merchandise classification service, the method comprising:
inputting information related an import transaction, the import transaction including the import of at least one item of merchandise;
storing the inputted information in association with at least one party to the import transaction; and
requiring the at least one party to subscribe to a merchandise classification service to access the inputted information.

13. A method for providing a merchandise classification system for customs compliance, comprising:
providing a plurality of access to a merchandise classification system for customs compliance;
wherein a first level access to a merchandise classification system is provided to a first level of users, the first level access being dependant on the first level of user's association with a classification determination; and
a second level access to the merchandise classification system for customs compliance to a second level of users, the second level access being dependant on the second level of user's association with a classification, and the first level of user's association with the classification determination is different than the second level of user's association with the classification determination; and
providing the first level access on a free basis as an inducement to attract the second level of users to use the merchandise classification system.

14. The method of claim 13 wherein the first level of users are at least one of governmental agencies, advisors or experts.

15. A system for providing merchandise classification for customs compliance, comprising:
means for at least one authorized party to remotely input data related to at least one item of merchandise;
means for the at least one authorized party to remotely access the inputted data;
means for searching a database of customs-related information to obtain classification information related to the at least one item of merchandise; and
means for storing the inputted data and the classification information.

16. The system of claim 15 wherein the database of customs-related information includes at least one of product classification, regulations, rulings, directives, registrations, duty notices, foreign codes, tariff schedules, explanatory notes, encyclopedias, and contact directory of customs advisors.

17. The system of claim 15 comprising:
means for the least one authorized party to remotely associate the stored inputted data and classification information with at least one second authorized party;
means for the at least one authorized party to remotely assign an action to the at least one second authorized party related to the inputted data and classification information;
means for storing the action taken by the at least one second authorized party;
means for generating a report based on the inputted data, classification information, the action assigned and the action taken by the at least one second authorized party; and
means for storing the report.

18. A system for creating a compliance audit trail for importing merchandise into a country, comprising:
means for at least one authorized party to remotely input data related to at least one item of merchandise;
means for the at least one authorized party operative to associate the inputted data with at least one second authorized party;
means for searching a database of customs-related information for information relating the inputted data;
means for comparing the inputted data to the database of customs-related information to obtain a classification of the at least one item of merchandise based on the inputted data;
means for transmitting the inputted data and classification to the at least one second authorized party for action;
means for receiving information related to the action from the at least one second authorized party; and
means for generating a report based on the results of the comparison to obtain classification of the at least one item, and the action of the at least one second authorized party.

19. The system of claim 18, comprising means for storing the report.

20. The system of claim 18 wherein the report comprises tariff product classification.

21. The system of claim 18 wherein the report identifies import duties for the at least one item of merchandise.

22. The system of claim 18 wherein the report provides tracking information for the merchandise.

23. The system of claim 18, wherein the means for searching the database of customs-related information is operative to search for new data relevant to the classification of the at least one item of merchandise; and means for notifying the at least one of the at least one authorized party, or the at least one second party of new data identified in the search.

24. A method for providing a merchandise classification system for customs compliance, comprising:
inputting information related to at least one item of merchandise;
searching a database of customs related information based on the inputted information;
receiving at least one result from the search of the database of customs related information; and
if more than one result, selecting at least one of the at least one results.

25. The method of claim 24 comprising:
storing the at least one selected result.

26. The method of claim 24 comprising:
associating the at least one selected result with at least one user;
tracking the at least one selected result for a change that affects the at least one selected result; and
notifying the at least one user of the change.

27. The method of claim 24 comprising:
generating merchandise classification information based on the at least one selected result.

28. The method of claim 24 comprising:
associating the at least one result or the at least one selected result with the at least one item of merchandise.

29. The method of claim 28 comprising storing the association and the at least one item of merchandise.

30. The method of claim 28 comprising basing a merchandise classification determination of the at least one item of merchandise on the associated at least one results or the at least one selected result.

31. The method of claim 28 wherein the associated at least one result or at least one selected result is accessed by links.

32. A method for providing a merchandise classification system for customs compliance, comprising:
providing a merchandise classification system for customs compliance having a searchable directory of advisors involved in merchandise classification; and
allocating the advisor's subscription fee to use the merchandise classification system to parties originating a merchandise classification determination.

33. A system for providing a merchandise classification method for customs compliance, comprising:
means for inputting information related to at least one item of merchandise;
means for searching a database of customs related information based on the inputted information;
means for receiving at least one result from the search of the database of customs related information; and
means for selecting at least one of the at least one results, if there is more than one result.

34. The system of claim 33 comprising means for storing the at least one selected result.

35. The system of claim 33 comprising:
means for associating the at least one selected result with at least one user;
means for tracking the at least one selected result for a change that affects the at least one selected result; and
means for notifying the at least one user of the change.

36. The system of claim 33 comprising:
means for generating merchandise classification information based on the at least one selected result.

37. The system of claim 33 comprising:
means for associating the at least one result or the at least one selected result with the at least one item of merchandise.

38. The system of claim 37 comprising means for storing the association and the at least one item of merchandise.

39. The system of claim 37 comprising means for basing a merchandise classification determination of the at least one item of merchandise on the associated at least one results or the at least one selected result.

40. The system of claim 37 wherein the associated at least one result or at least one selected result is accessed by links.
